(19) United States
(12) Patent Application Publication
(10) Pub. No.: US 2023/0215221 A1
(43) Pub. Date: Jul. 6, 2023

(54) HANDWRITTEN POSTAGE

(71) Applicant: HALLMARK CARDS, INCORPORATED, KANSAS CITY, MO (US)

(72) Inventors: Jennifer R. GARBOS, Kansas City, MO (US); Andrew C. OLSON, Kansas City, MO (US); Krista M. MASILIONIS, Leawood, KS (US)

(21) Appl. No.: 18/150,687

(22) Filed: Jan. 5, 2023

Related U.S. Application Data
(60) Provisional application No. 63/266,504, filed on Jan. 6, 2022.

(51) Int. Cl. G07B 17/00; G06V 30/14; G06V 30/244

(52) U.S. Cl. CPC G07B 17/00661; G06V 30/1448; G06V 30/2455; G06Q 2250/90; G07B 2017/00725

(57) ABSTRACT

The technology described herein provides a handwritten postage that comprises handwriting on a postal item that forms a unique identifier for the postal item (e.g., envelope, postcard, sticker) when analyzed by a computer vision application. The unique identifier is computer derived from the handwritten postage and allows one instance of handwritten postage to be differentiated from all other instances of handwritten postage. The unique identifier may be derived from an image of an envelope that includes an instance of handwritten postage when the handwritten postage is activated. The unique identifier may be formed from a combination of handwriting content (e.g., to and from address), metadata (e.g., date activated), pre-printed content on the postal item (e.g., fiducial marks), post-printed content (e.g., to or from address) and the visual image created by all or a portion of the handwriting. Postage value is added to the handwritten postage through an activation process.

### CROSS REFERENCE TO RELATED APPLICATIONS

This application claims the benefit of U.S. Provisional Application No. 63/266,504 filed Jan. 6, 2022.

### BACKGROUND

Postage can be added to an item, such as a letter or package, in a number of different ways. Carriers, such as the United States Postal Service (USPS) sells fixed value stamps that may be adhered to an envelope. Franking machines can print postage directly onto an envelope. Customers can go to a kiosk at a post office or other location and receive the correct postage for a package by weighing the package and providing a destination. In these examples, the postage indication, such as a stamp, has a fixed value when printed.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Aspects of the technology described herein provide a handwritten postage. The handwritten postage has several advantages over the pre-printed postage stamps and on-demand printed postage that is used today, including improved fraud prevention. The handwritten postage described herein is less susceptible to fraud, especially forgery, than current postage for at least two reasons. First, each instance of the handwritten postage has a unique appearance, in contrast to stamps, which have millions of instances of the exact same stamp. Second, authentication of the handwritten postage requires a postage value to be associated with an individual instance of handwritten postage in a central database. Thus, forging an instance of handwritten postage requires a forger to both reproduce the appearance of the handwritten postage and hack a database to associate the postage value with an identifier that is machine coded within the handwritten postage.

The handwritten postage will often be described herein in terms consistent with use with the United States Post Office. The handwritten postage certainly can be used with items transported by the United States Post Office. However, the handwritten postage is not limited to use with the United States Post Office. The handwritten postage can also provide a payment mechanism for transportation of an item (e.g., letter, package) by any carrier, including FedEx or UPS. As will be seen, coordination between the carrier and the provider of the handwritten postage is required for the carrier to accept and authenticate the handwritten postage.

As used herein, handwritten postage comprises handwriting on a postal item that forms a unique identifier for the postal item (e.g., envelope, postcard, sticker) when analyzed by a computer vision application. The unique identifier is computer derived from the handwritten postage and allows one instance of handwritten postage to be differentiated from all other instances of handwritten postage. The unique identifier may be derived from an image of an envelope that includes an instance of handwritten postage when the handwritten postage is activated. The unique identifier is then stored in a postage database that is accessible to a postage carrier. Upon receiving an envelope with handwritten postage, a postage carrier may generate a validation identifier from the handwritten postage following the same process used during the activation process. The validation identifier is then compared to unique identifiers in the postage database. If a match is found, the handwritten postage is validated. If a match is not found, then the handwritten postage is rejected. Once validated, the postage carrier can update the postage database to indicate the handwritten postage instance has been used and is no longer valid.

The unique identifier may be formed from a combination of handwriting content (e.g., to and from address), metadata (e.g., date activated), pre-printed content on the postal item (e.g., fiducial marks, phantom stamp), post-printed content (e.g., to or from address) and the visual image created by all or a portion of the handwriting. As used herein, pre-printed content is content added during the postal item creation process, such as when an envelope is printed. The post-printed content is added to the postal item apart from the postal item generation process, such as might occur when a user writes on an envelope. The pre-printed content may include visible content, such as a design or to and from indications. The pre-printed content may also include invisible content (not visible to the naked eye), such as a watermark or UV barcode printed in infrared ink, which can be visible to infrared cameras. The watermark or UV barcode can indicate to a postage carrier that the envelope includes a handwritten postage instance. Detection of the watermark or UV barcode may trigger special processing by the postage carrier to identify and validate the handwritten postage.

Different categories of handwriting may form the unique identifier. The handwriting on the postal item may include a handwritten “from” address, a handwritten “to” address, a customized message, and a stamp doodle. While the technology may work with generic envelopes, specialty envelopes may include areas designated to receive these categories of handwriting. The stamp doodle may include a stamp area boundary that encodes content, such as the size or weight of a postal item. The weight of a postal item may include the content of the postal item, such a greeting card. A user may draw a stamp doodle, such as a caricature of the recipient's face in the stamp doodle area. The customized message could include a brief note to the recipient and may include a signature.

The to area, from area, stamp doodle area, and the customized message area may each include a boundary. In an aspect, one or more these areas include fiducial marks that help form a unique identifier in combination with the handwriting. In other aspects, fiducial marks are not used. As mentioned, aspects of the technology described herein generate a unique identifier from a user's handwritten marking, such as a signature, address, doodle, note, or drawing. The unique identifier is unique because of visual characteristics created by a user's handwritten marking in combination with the location of the marking on the postal item, content of the handwriting, and other features. In one aspect, the handwriting in the custom message area includes a handwritten signature. In general, people have unique signatures when they are handwritten. For example, it would be rare for two people with the same name to have visually identical signatures. That is especially true because the signature is being analyzed by a computer imaging system, which can detect fine distinctions. As used herein, a signature is a visible production of all or part of a user's name by hand using a pen, pencil, stylus, finger, or other writing implement. The signature could be in cursive or printed letters. The signature can also comprise entirely a mark or marks the user commonly uses to identify himself or herself.

The location of the handwriting, such as a signature, on the postal item can be determined by including preprinted fiducial marks on the postal item. In general, it is beneficial for a fiducial marker to be a unique pattern that is easy for the computer software to recognize as a fiducial marker. It is also beneficial for the marker to be asymmetrical. It is easier to determine the relative positioning of the camera and the marker if some aspect of the marker is asymmetrical. An asymmetrical marker makes it possible for the vision software to determine which way the marker is oriented.

The fiducial markers act as landmarks that allow the size and location of the marking to be determined in absolute terms. The absolute size and location of the marking in combination with the handwritten marking itself can be used to create a unique identifier that in turn identifies the visual postal item to which the signature is affixed.

Postage value is added to the handwritten postage through an activation process.

### BRIEF DESCRIPTION OF THE DRAWINGS

Aspects of the invention are described in detail below with reference to the attached drawing figures, wherein:

FIG. 1 is a block diagram of an example process flow for printing, in accordance with an aspect of the technology;

FIGS. 1A-1F are a block diagrams of an example process flow for printing, activating, and using handwritten postage, in accordance with an aspect of the technology;

FIG. 2 is a flow chart showing a method for printing, activating, and using handwritten postage, in accordance with an aspect of the technology;

FIGS. 2A-F are a flow charts showing a detailed view of a method for printing, activating, and using handwritten postage, in accordance with an aspect of the technology;

FIG. 3 is a sequence diagram showing a method of paying for handwritten postage, in accordance with an aspect of the technology;

FIG. 4 is a diagram showing UV markings on an envelope, in accordance with an aspect of the technology;

FIG. 5 is a diagram illustrating the use of stamp boarder designs to communicate information about an envelope, in accordance with an aspect of the technology;

FIG. 6 is a diagram illustrating envelope areas, in accordance with an aspect of the technology;

FIG. 7 is a diagram illustrating a handwritten signature and fiducial marks, in accordance with an aspect of the technology;

FIG. 8 is a diagram illustrating capture of a handwritten signature with a computing device, in accordance with an aspect of the technology;

FIG. 9 is a block diagram of an example operating environment suitable for implementing aspects of the technology;

FIG. 10 is a diagram depicting an example computing architecture suitable for implementing aspects of the technology;

FIG. 11 depicts a flow diagram of a method for activating pre-printed postage, in accordance with an aspect of the technology;

FIG. 12 depicts a flow diagram of a method for processing and deactivating handwritten postage, in accordance with an aspect of the technology;

FIG. 13 depicts a flow diagram of a method for processing handwritten postage, in accordance with an aspect of the technology; and

FIG. 14 is a block diagram of an example computing environment suitable for use in implementing an aspect of the technology.

### DETAILED DESCRIPTION

The subject matter of aspects of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the technology described herein provide a handwritten postage. The handwritten postage has several advantages over the pre-printed postage stamps and on-demand printed postage that is used today, including improved fraud prevention. The handwritten postage described herein is less susceptible to fraud, especially forgery, than current postage for at least two reasons. First, each instance of the handwritten postage has a unique appearance, in contrast to stamps, which have millions of instances of the exact same stamp. Second, authentication of the handwritten postage requires a postage value to be associated with an individual instance of handwritten postage in a central database. Thus, forging an instance of handwritten postage requires a forger to both reproduce the appearance of the handwritten postage and hack a database to associate the postage value with an identifier that is machine coded within the handwritten postage.

The handwritten postage will often be described herein in terms consistent with use with the United States Post Office. The handwritten postage certainly can be used with items transported by the United States Post Office. However, the handwritten postage is not limited to use with the United States Post Office. The handwritten postage can also provide a payment mechanism for transportation of an item (e.g., letter, package) by any carrier, including FedEx or UPS. As will be seen, coordination between the carrier and the provider of the handwritten postage is required for the carrier to accept and authenticate the handwritten postage.

As used herein, handwritten postage comprises handwriting on a postal item that forms a unique identifier for the postal item (e.g., envelope, postcard, sticker) when analyzed by a computer vision application. The unique identifier is computer derived from the handwritten postage and allows one instance of handwritten postage to be differentiated from all other instances of handwritten postage. The unique identifier may be derived from an image of an envelope that includes an instance of handwritten postage when the handwritten postage is activated. The unique identifier is then stored in a postage database that is accessible to a postage carrier. Upon receiving an envelope with handwritten postage, a postage carrier may generate a validation identifier from the handwritten postage following the same process used during the activation process. The validation identifier is then compared to unique identifiers in the postage database. If a match is found, the handwritten postage is validated. If a match is not found, then the handwritten postage is rejected. Once validated, the postage carrier can update the postage database to indicate the handwritten postage instance has been used and is no longer valid.

The unique identifier may be formed from a combination of handwriting content (e.g., to and from address), metadata (e.g., date activated), pre-printed content on the postal item (e.g., fiducial marks, phantom stamp), post-printed content (e.g., to or from address), visually discernable physical characteristics (e.g., a unique die cut edge to the envelope, internal die cut (e.g. to create a window), a fold or crease, a angled cut, a ratio of long edge to short edge) and the visual image created by all or a portion of the handwriting. As used herein, pre-printed content is content added during the postal item creation process, such as when an envelope is printed. The post-printed content is added to the postal item apart from the postal item generation process, such as might occur when a user writes on an envelope. The pre-printed content may include visible content, such as a design or to and from indications. The pre-printed content may also include invisible content (not visible to the naked eye), such as a watermark or UV barcode printed in infrared ink, which can be visible to infrared cameras. The watermark or UV barcode can indicate to a postage carrier that the envelope includes a handwritten postage instance. Detection of the watermark or UV barcode may trigger special processing by the postage carrier to identify and validate the handwritten postage.

The handwriting may be wet ink or electronic ink. Wet ink is written directly on the postal item by a person using a pen or other writing instrument (e.g., a plotter—a robotic arm holding a pen). Electronic ink is formed when a user writes on an electronic capture device, such as a touch screen or digitizing pad. Electronic ink may also be formed by capturing an image of handwriting on another medium. Electronic ink is then printed onto the postal item using a printing device, such as a laser or inkjet printer. If the handwriting is electronic ink, then the printed image of the electronic ink may be captured to activate the handwritten postage.

Different categories of handwriting may form the unique identifier. The handwriting on the postal item may include a handwritten “from” address, a handwritten “to” address, a customized message, and a stamp doodle. While the technology may work with generic envelopes, specialty envelopes may include areas designated to receive these categories of handwriting. The stamp doodle may include a stamp area boundary that encodes content, such as the size or weight of a postal item. The weight of a postal item may include the content of the postal item, such a greeting card. A user may draw a stamp doodle, such as a caricature of the recipient's face in the stamp doodle area. The customized message could include a brief note to the recipient and may include a signature.

Content may be extracted from the handwriting and used to form the unique identifier. In one aspect, the content is extracted using optical character recognition (OCR) tuned to recognize handwriting. Types of content that may be extracted include, the “from” address, the “to” address, the name indicated by a signature, a personal message, and the like. The content can be used to form part of the unique identifier.

Once generated, the handwritten postage needs to be activated. Metadata generated during the activation process can be used to form part of the unique identifier. Examples of metadata generated include, the date activated, the postage amount, the to address, the from address, a location of activation (e.g., derived from location data on a smart phone on which an activation application is running), and the like. While the metadata is not visible on the postal item to which the handwritten postage is added, the metadata can be stored in a handwritten postage database that associates metadata with individual instances of postage. In general, people place items in the mail soon after adding postage. This knowledge can be used to increase the efficiency of a search that occurs during postage validation at the post office or other carrier by first searching postage within a recent time range, such as the last two weeks. The to and from zip codes could be used in a similar way to increase the efficiency of a search.

The to area, from area, stamp doodle area, and the customized message area may each include a boundary. In an aspect, one or more these areas include fiducial marks that help form a unique identifier in combination with the handwriting. In other aspects, fiducial marks are not used. As mentioned, aspects of the technology described herein generate a unique identifier from a user's handwritten marking, such as a signature, address, doodle, note, or drawing. The unique identifier is unique because of visual characteristics created by a user's handwritten marking in combination with the location of the marking on the postal item, content of the handwriting, and other features. In one aspect, the handwriting in the custom message area includes a handwritten signature. In general, people have unique signatures when they are handwritten. For example, it would be rare for two people with the same name to have visually identical signatures. That is especially true because the signature is being analyzed by a computer imaging system, which can detect fine distinctions. As used herein, a signature is a visible production of all or part of a user's name by hand using a pen, pencil, stylus, finger, or other writing implement. The signature could be in cursive or printed letters. The signature can also comprise entirely a mark or marks the user commonly uses to identify himself or herself.

The location of the handwriting, such as a signature, on the postal item can be determined by including preprinted fiducial marks on the postal item. In general, it is beneficial for a fiducial marker to be a unique pattern that is easy for the computer software to recognize as a fiducial marker. It is also beneficial for the marker to be asymmetrical. It is easier to determine the relative positioning of the camera and the marker if some aspect of the marker is asymmetrical. An asymmetrical marker makes it possible for the vision software to determine which way the marker is oriented.

The fiducial markers act as landmarks that allow the size and location of the marking to be determined in absolute terms. The absolute size and location of the marking in combination with the handwritten marking itself can be used to create a unique identifier that in turn identifies the visual postal item to which the signature is affixed.

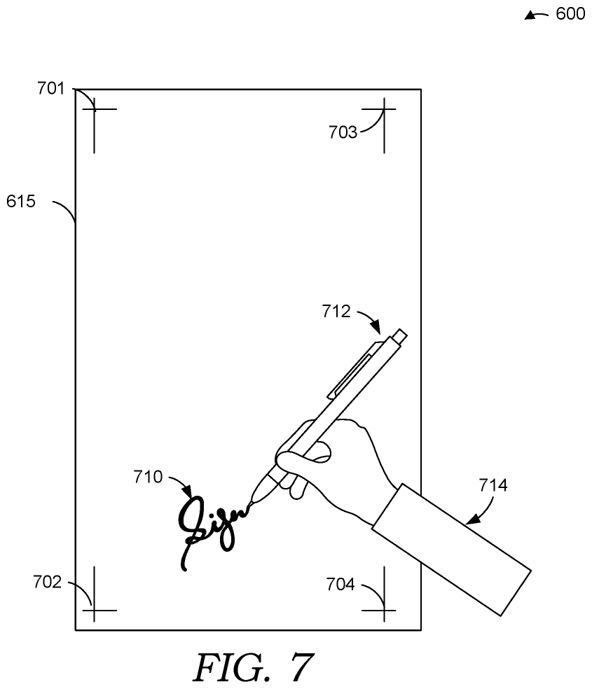

As used herein, the fiducial marks can be stand-alone marks, integrated marks, or derived from the actual design on the postal item (i.e., natural feature tracking). The stand-alone marks are visible apart from a design on the postal item. Stand-alone marks are illustrated with reference to FIG. 7. The examples herein are described in terms of stand-alone fiducial marks, but these examples are not intended to be limiting. Any type of fiducial mark or mark serving the purposes of the fiducial mark described herein, regardless of designation, may be used.

The fiducial marks can also be integrated. Integrated fiducial marks may also be described as aesthetic marks. Integrated fiducial marks are integrated into a design or possibly designed around. The typical user would not recognize the integrated fiducial marks as anything other than the design because they are often just shapes commonly seen in different designs. For example, the integrated fiducial marks can be a pair of circles, ovals, or other shapes. The design development may be performed with any color, texture, shape or other features as long as the circle (or other shape) pairs are integrated. The ratio of the radius of two circles in a pair can uniquely identify an integrated mark from a look up table. Other characteristics of the mark and associated postal item, if applicable, could be extracted from the look up table and used to perform operations described herein. For example, spatial information could be retrieved from the look up table and used to identify characteristics of a signature or other user mark on a postal item.

In one aspect, the fiducial marks use natural feature tracking. Natural feature tracking evaluates a design with machine vision technology and identifies key points within a design that can serve as fiducial marks. For example, the features could include corners, edges, blobs, without using specifically designed ID markers. These features allow the system to identify the specific design, along with the spatial features of the postal item on which the design is found. Understanding the spatial features of the design allow for the spatial features of a signature or other mark to be identified, as described subsequently.

As an initial step, the handwritten postage is added to a postal item, such as an envelope or sticker. As mentioned, the handwritten postage can be added in wet ink or printed electronic ink. Initially, the handwritten postage has no postage value and will not have any value until activated. Each instance of handwritten postage can be used to derive a unique identifier.

As mentioned, the technology described herein can work with electronic ink. For example, a handwritten postage provider could provide a mailing service, such as could be used to send out a batch of customized wedding invitations, holiday cards, or the like. A handwritten postage application could receive a list of recipients and corresponding mailing addresses. For each recipient, the user could write a handwritten customized message and/or stamp doodle. In another aspect, the same message and/or doodle is used for each recipient. The user could be given the option of reusing the customized message or doodle. The handwritten postage provider then prints each of these postal items, such as a card or envelope, with the customized message and stamp doodle visibly printed in the user's handwriting. In one aspect, the “to” and “from” addresses may be printed in a font, rather than the user's handwriting. This prevents the need for the user to write each address. Even when printed in a font, the “to” and “from” addresses may still form part of the handwritten postage when combined with the handwritten message and/or doodle. Note, than even if the doodle and message are exactly the same on each handwritten postage instance, each instance would be visually unique by virtue of a unique “to” address. This allows a unique identifier to be generated for each handwritten postage instance generated from electronic ink according to the example provided above.

Postage value is added to the handwritten postage through an activation process. The activation process utilizes a computer application running on a computing device. In one aspect, the computing device is a user device, such as a smart phone, PC, or tablet. In another aspect, the computing device is part of a kiosk provided in a public location, such as a post office or store. In one aspect, an activation kiosk is provided within or nearby a stationary section of a drug store, grocery store, or other store where greeting cards and other stationary may be purchased.

In order to activate an individual instance of handwritten postage, an image of the handwritten postage needs to be provided to the activation application. In one aspect, the image of the handwritten postage is retrieved by taking a picture of the postal item (e.g., envelope, post card) to which the handwritten postage is attached. For example, the camera on a smart phone may capture an image of the handwritten postage. The image can be provided by the camera to the activation application which generates a unique identifier from the image, and possibly other information provided.

In one aspect, the unique identifier is analyzed to confirm that it is unique. In one aspect, it is compared to other unique identifiers generated by same user. It is highly unlikely, that different users could create handwritten postage that would result in duplicate unique identifiers. Limiting the comparison to only unique identifiers associated with a single makes efficient use of computer resources. In one aspect, the handwritten postage application stores all unique identifiers generated by the user and performs a client-side comparison. In other aspects, the unique identifier is generated in a cloud-based service and the comparison is run by the cloud-based service. Other uniqueness confirmation arrangements are possible.

Once the unique identifier is obtained from the individual instance of handwritten postage, the user can provide information about the item to be posted. The information can include a size and weight of the item. Alternatively, the handwritten postage application can provide examples for the user to select. For example, a user can be asked to select images of envelopes having different sizes with different amounts of paper in each envelope. Every size combination does not need to be provided, instead representative sizes and amounts of paper can be used to estimate the appropriate postage rate for the item. In one aspect, a UPC label on a greeting card or other item may be scanned to retrieve a size and weight of the item. The handwritten postage application may prompt the user to scan the greeting card or other postal item in order to retrieve a size and weight, postal category, or other information that can be used to calculate the postage rate. The user may also be asked to provide a destination address. In one aspect, the handwritten postage application includes the ability to read handwriting. In this instance, the destination address could be obtained by scanning the address listed on the item. In another aspect, the user provides the ZIP Code of the destination.

Once the item information is provided, the postage rate is calculated. The user may be asked to confirm the amount or authorize payment in the amount of the calculated postage rate, plus any markup, service fees, etc. Once confirmation is obtained, the application sends a message to a central postage database. The central postage database is updated to associate the unique identifier with a postal value equal to the postage rate. Other information may also be included within the database, such as a destination ZIP Code.

The activation process on a public device can differ from the activation process on a private device. On a private device, the user can establish an account when downloading and installing the application. The user account may be linked to a payment method, such as a credit card, PayPal, Apple pay, prepaid postage account, or other electronic payment mechanisms. Once the application is set up, the user may not need provide any additional user/payment information during the postage activation process.

In contrast, on a public device, such as may be found in a kiosk, the user may be asked to login if the user already has a handwritten postage account. If the user does not already have an account, the user may need to create an account or at least provide enough information to complete a payment process. Once payment is made, the user may deposit the item with the United States Post Office or other carrier.

When the carrier receives an item with handwritten postage it authenticates the handwritten postage and then deactivates the handwritten postage. The carrier authenticates the handwritten postage by generating a validation identifier from the handwritten postage. The validation identifier may be extracted by capturing an image of the handwritten postage and inputting the image into a computer vision process that extracts the same features as those extracted when creating the unique identifier. In essence, the same visual analysis process used to create the visual feature extraction portion of the validation identifier is also used to create the visual feature extraction portion of the unique identifier. The validation identifier may also include context, such as the date the validation is occurring and a location of the validation. The validation identifier can include content extracted from the image of the handwritten postage, such as the message content, the to address, and the from address. In aspects, only portions of the content are extracted, such as just the zip code and a signature in the customized message area.

An attempt is then made to compare the validation identifier with the unique identifier. The comparison may use a threshold value of similarity for validation. In other words, the images may not match exactly (accounting for stray marks received in transit, differences in image capture due to differing optical equipment, shadows in the image capture environment, etc.), but a threshold match would be identified and would have to exist for a validated comparison. Additionally, the threshold may be set to ensure the match is more similar than may be encountered with coincidental matching (e.g. same signature by the same sender, common doodles that lack enough details for differentiation, etc.). When a match is validated, the unique identifier is looked up within the centralized database and the postage value associated with the unique identifier is retrieved. The postage value in the database may be compared to a postage rate calculated by analyzing the item at the post office. If the postage value is equal to or greater than the postage rate, then the post office updates the central database by deactivating the unique identifier. Once deactivated, the individual instance of the handwritten postage will no longer work as postage. If the postage is not adequate, then the post office can take steps to deal with having inadequate postage.

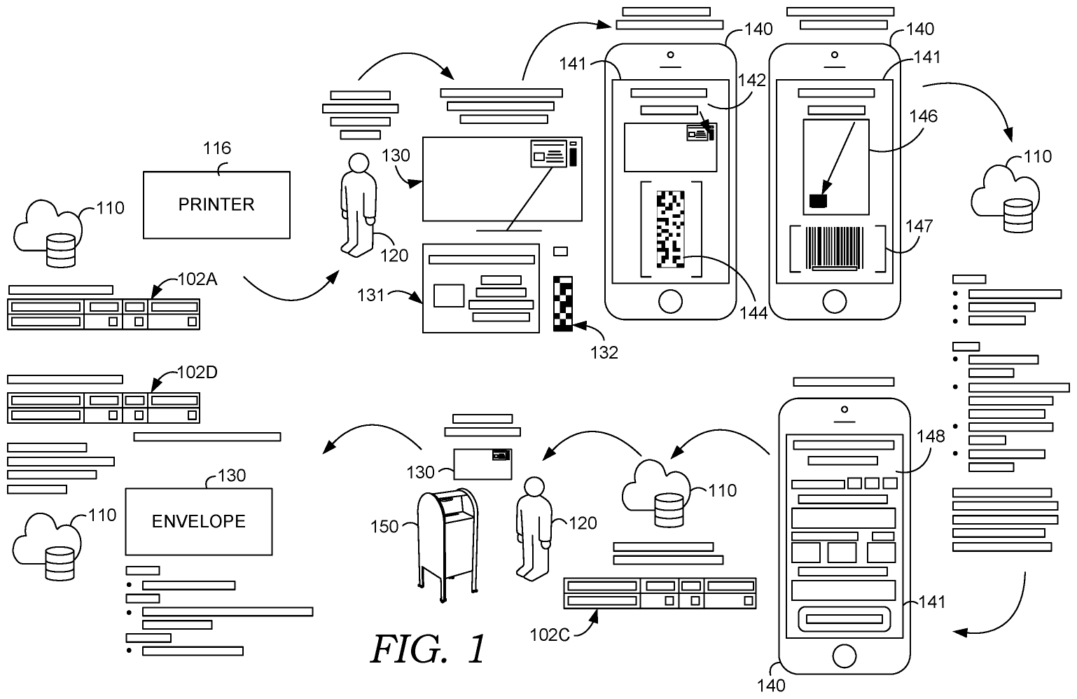

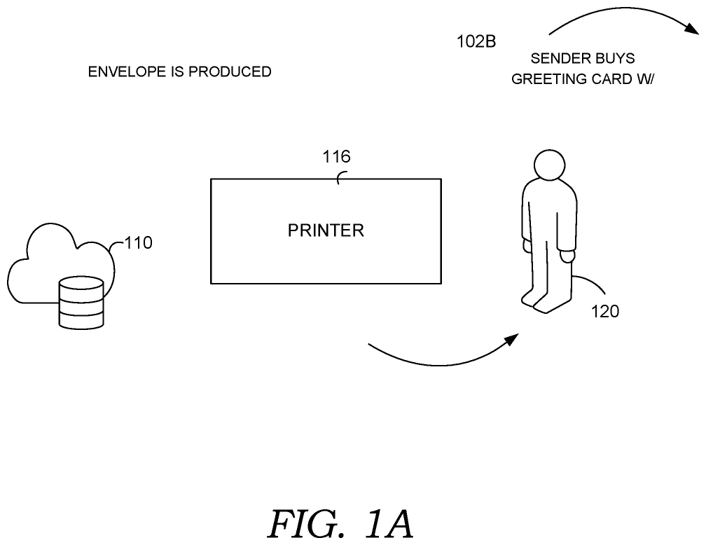

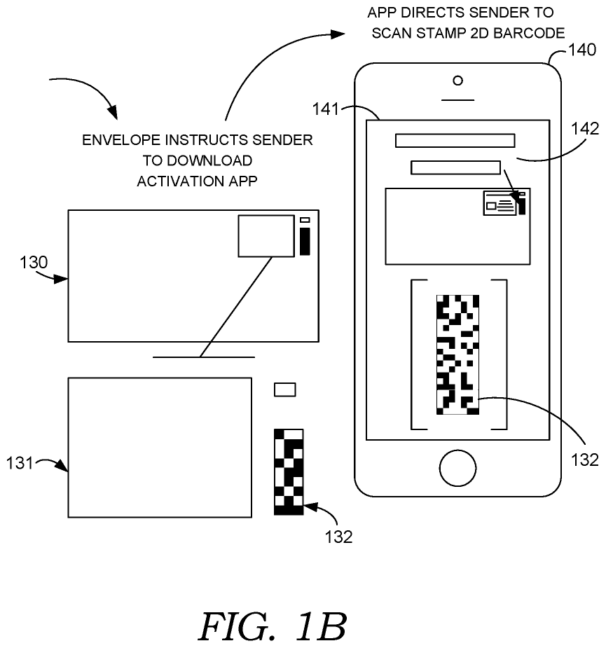

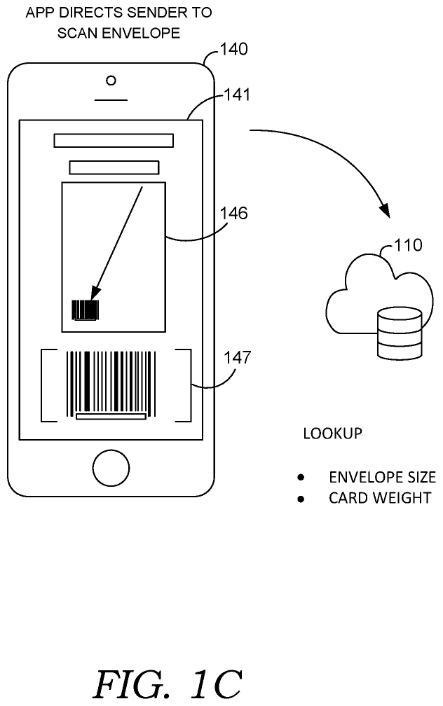

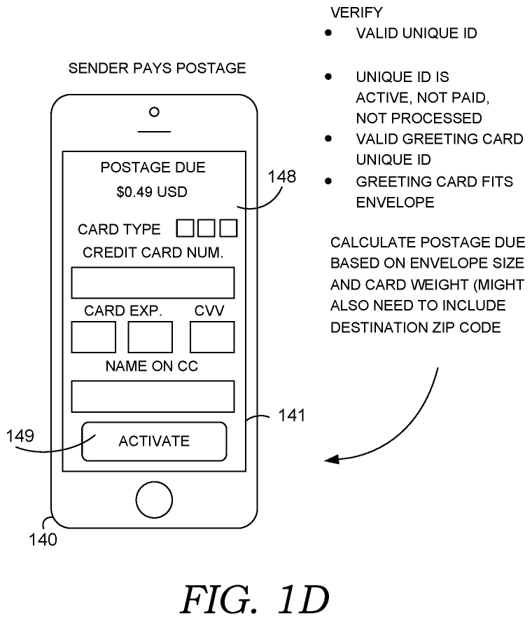

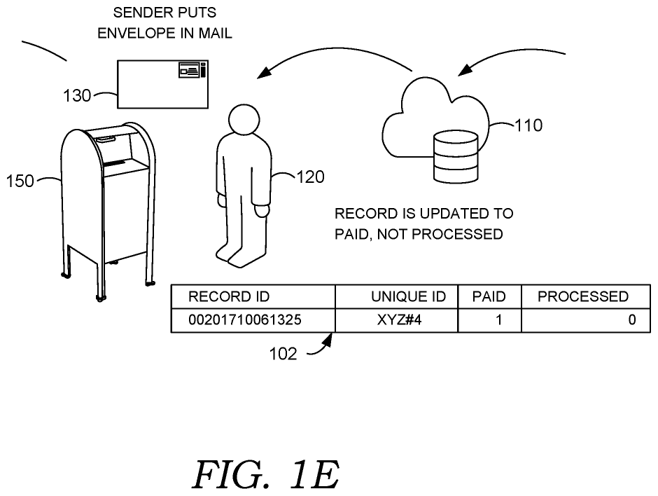

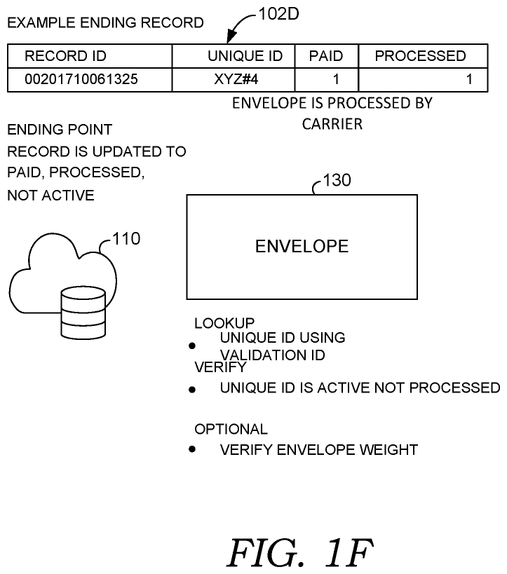

Various implementations are described with reference to FIGS. 1-3. In an aspect, a traditional stamp is replaced with handwritten postage, which comprises a handwritten object that is captured by a user's phone. The phone includes a postage activation application (“app”) that captures the image of the handwritten object, allows the user to calculate and pay the desired/required postage, activate the handwritten postage with a mail carrier that will take the item from the sender/gift giver to the recipient/gift receiver, and follow the progress of the item along its path to the recipient/gift receiver.

The manufacturer of the postal item (e.g., envelope) does not have to pay the postage at the time of manufacture and the purchaser of the envelope does not have pay the cost of the postage (which could be unknown at the time of the purchasing of the envelope) at the time of purchase of the envelope or a product that contains one such envelope. The handwritten postage is not usable until it is activated, but is activatable by the user/sender of the envelope. The handwritten postage need only be unique, such that it may be tied to that particular envelope.

When the purchaser or possessor of the envelope desires to use it to send the envelope via mail (e.g., First Class mail via the U.S. Postal Service) or other carrier service (e.g., an overnight delivery service, such as UPS, FedEx, or some other service that transports items, such as messenger service, Uber drivers, airlines, trucking companies, individuals, etc.), that person opens the activation feature of the handwritten postage application. In one aspect, an envelope may include a QR code that causes the handwritten postage application to be opened. The postage activation app may already be active when a QR code is scanned. The postage activation app integrates the scanning feature (whether QR, UPC, NFC, etc.) with a prompt to the user to enter or scan the destination zip code or address printed or written on the front of the envelope. This can be done manually or by taking a photo of the front of the envelope and character recognition software used to enter the destination address into the app.

The user could also be prompted to enter in information about the item being placed in the envelope. In this example embodiment, the contents of the envelope is a greeting card. Accordingly, the user could scan, with the camera of their phone in the app, the UPC of the greeting card. This information could then be sent through the app to a database which contains information on the specifics of the card, including size and weight. The card specifics can be sent back to the app to allow the app to calculate the desired postage needed at the then current rates of the mail or carrier service being used to transport the envelope from its current location (which, if relevant, can be determined by the GPS location of the phone or entered manually by the user) to the destination.

The app would then present the user with the calculated amount and prompt the user to confirm they want to use the calculated amount or add additional postage if they have modified the package in some way. For example, if the user placed photographs or gift cards in the greeting card, the user would select the option to add additional postage to cover the increased weight. Similarly, the user could add increased postage, in some instances, to increase the speed at which the envelope is moved along its route (e.g., overnight vs. standard ground transportation). The app could prompt the user with these choices and options and help them determine the additional amount needed.

Once the postage is determined, the user is prompted to pay the postage calculated via their mobile device. This could be done, for example, via a credit card payment. The user may have a credit card stored in the postage activation app or they may scan their credit card via the camera of their phone through the app which captures the information via character recognition technology. Other means for payment in a mobile environment are possible and contemplated and within the scope of the technology described herein.

Once the payment has been made, the handwritten postage is “live” or activated. The unique identifier generated from the handwritten postage, along with the purchase details, including postage, may be transmitted to the responsible carrier. In the present example, the fact that the handwritten postage has been activated and the postage associated with the handwritten postage would be communicated to the carrier (e.g., USPS, UPS, FedEx). The carrier would then enter this information into their database of active unique identifiers so that when the envelope is scanned and sorted through existing postal systems, once the user puts it in the postal stream, the handwritten postage would be recognized as active and valid postage and the envelope would be delivered to its destination. The money collected through the alternative postage purchase process, or a portion thereof, would then be transferred to the appropriate mail or carrier service, so they are paid for transporting the envelope.

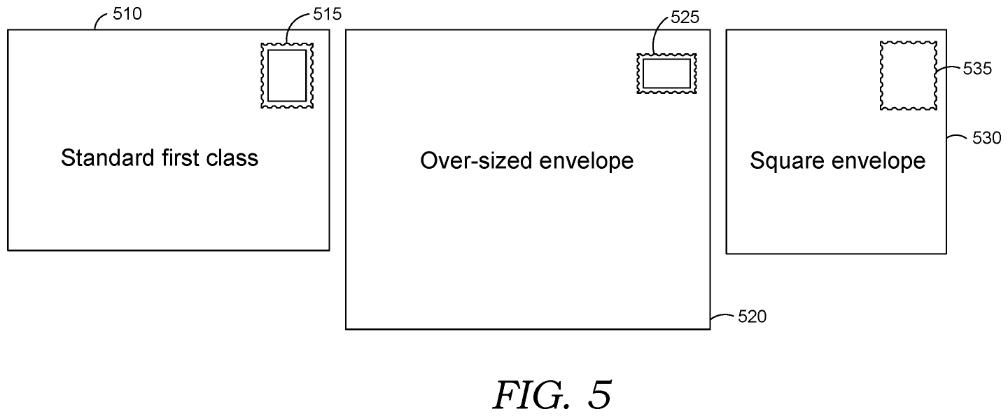

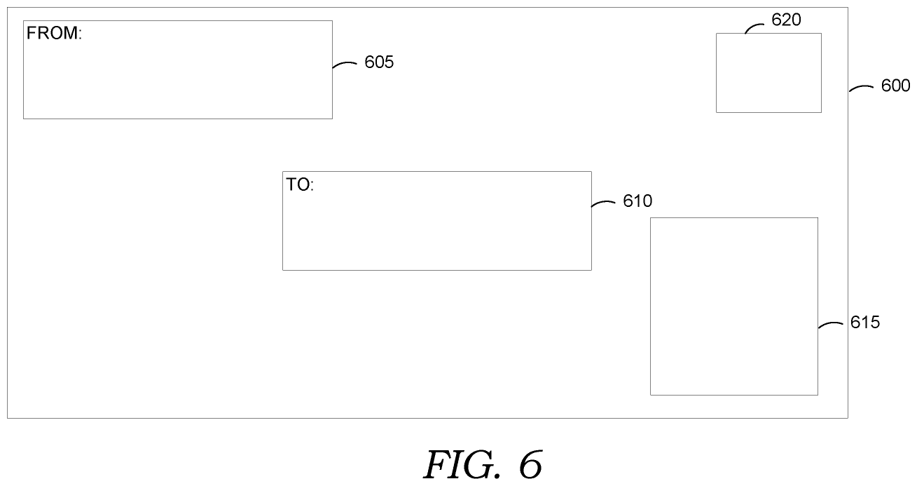

Turning now to FIG. 1, a graphical overview of an example version of the technology described herein, is disclosed. FIG. 1 is broken into smaller portions that are enlarged and provided as FIGS. 1A-1F. FIG. 1A discloses a “starting point” of the illustrated embodiment. The process shown in FIG. 1 is just one possible way the technology described herein could be implemented. Here an envelope printer 116, such as Hallmark Cards, Incorporated (“Hallmark”), prints a postal item, such as an envelope or post card. Example envelopes and features of the envelopes are described in FIGS. 5 and 6. However, in brief, a handwritten-postage envelope may include a designated custom message area and a stamp doodle area. A to address area and from address area may also be designated. In one embodiment, the central postage database 110 is ready to receive unique identifiers for the activated handwritten postage.

Turning back to FIG. 1A, once the envelope is printed, it is then put in the stream of commerce where a “SENDER” 120 purchases the envelope, perhaps along with a greeting card. It should be noted that the envelopes could be sold without accompanying items such as greeting cards. Users could buy them for sending their regular mail. In this manner they would never need to go purchase stamps, as they could simply activate them when needed and the then current postage rate could be applied.

In FIG. 1B, we see that where one would normally place a stamp (i.e., in the upper right-hand corner) a visual marker is placed to convey to the user of the envelope that the envelope doesn't need a stamp but that the user may use handwriting as a stamp. This area could also include instructions for how to use handwriting as a stamp or marketing information about the new feature or the brand of cards. The visual marker may include stamp-like graphics, logos, and other items, such as various borders that communicate information about the envelope. It may optionally include the barcode 132, which is used to open the handwritten postage application or take the user to a location where the application may be downloaded. The barcode 132 could link to an instructional video teaching how to use the handwritten stamp system.

The user downloads the postage activation app (in this case identified as the ACTIVATION app) and installs the same. This may be done prior to scanning. However, if the sender 120 has not yet downloaded or installed the activation application, then they may be prompted to download upon scanning the handwritten postage. When the app is opened the user has the option to proceed with the process to activate a “stamp” or envelope. One step in that process is to take a picture of the envelope. In aspects, this may involve taking a picture of the front and back of the envelope. In other aspects, a user may be asked to capture multiple images capturing different features, such as the to address, from address, stamp doodle, and customized message areas. The GUI 141 may graphically direct or illustrate 142 to the user the portions of the envelope to capture. Once the handwritten postage is captured, a unique identifier may be generated from it.

While not illustrated (as it is not necessary in this embodiment), the user may also be prompted to enter information about the destination of the envelope, as this may affect the postage due. The user could key in the information manually though a keyboard displayed on their phone, use speech-to-text voice recognition, or may use the same camera and scanning process used to capture the barcode to capture the address written on the front of the envelope. The app can include character recognition software to identify the letter and numbers in the image to enter destination information, such as city and zip code. This can be used in the relationship app later, in addition to being used in fee calculation. A further step could be provided to give the user the ability to speed up the delivery process by paying an increased fee (e.g., for overnight delivery when used with such carriers).

In FIG. 1C, the user is instructed 146 to provide information about what is being sent inside the envelope. Where, as here, the user is sending a greeting card in the envelope, the user may provide information about the contents simply by scanning the UPC 147 of the greeting card. That information is sent to a database 110 which collects details on the card being sent, including the size and weight of the card. The database 110 may also be used to store the image of handwritten postage and/or envelope. The contents information is then sent to the database as well. This is the “Lookup” step. The verification process begins, including checking with the database to confirm the barcode is valid.

Once the lookup process has occurred, the app uses the gathered information, along with the known information on costs provide by the carrier of the envelope, to determine the postage due 148. The calculated postage due 148 is displayed to the user and they are prompted to pay the amount through the app. In the illustrated embodiment, a user is prompted to enter their credit card information. This information can be stored in the app for later purchases. Alternatively, the same camera and scanning process used above can be used to scan (i.e., capture an image of) the user's credit card and the character recognition software can determine the numbers/characters and enter them for the user. Any other online payment options and payment verification methods may be used at this step. Once the information is entered, the user indicates they want the handwritten postage activated, in this case by pressing the “ACTIVATE” icon 149.

Once activated, the sender 120, in FIG. 1E, hands the envelope 130 over to the carrier, which, in this case, is putting the envelope in a mailbox 150. Also, upon activation and payment, the record 102 associated with the unique identifier in the database 110 is generated to indicate the handwritten postage is not only active, but also paid (i.e., valid postage ready to be used). The record 102 includes a record identifier, the unique identifier, a paid indication, and processed activation. A one indicates yes and a zero no. To be active, the record should indicate the unique identification is paid for, but not processed.

FIG. 1F illustrates the envelope 130 passing through a carrier's handling system. Here, the handwritten postage is scanned by a postal machine, a validation identification generated, and compared with unique identifiers in the database. If the handwritten postage is active and paid, but not yet processed, the envelope is allowed to pass through and go out for delivery. If it was not activated or paid for, or if it was already processed, the envelope can be treated like any other envelope received by the carrier that doesn't include postage. The postal system can also verify that the weight of the envelope is the proper amount for the postage that was paid. If the envelope is heavier than the amount calculated, the envelope may again be treated like any other piece of mail with insufficient postage. When everything is correct and verified, the envelope is sent on for delivery and the database record 102D is updated to show the handwritten postage as now processed (i.e., already used—the equivalent of a cancelled stamp).

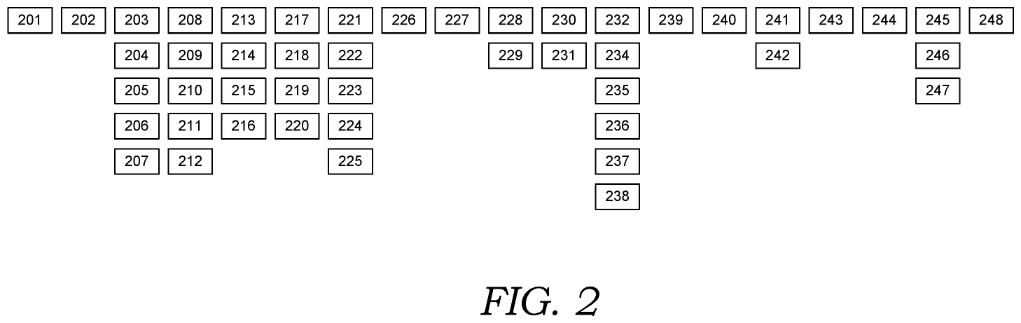

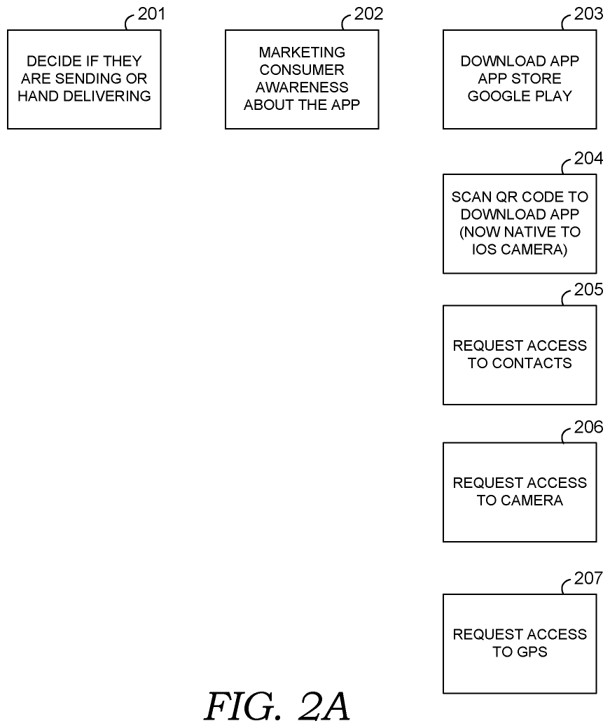

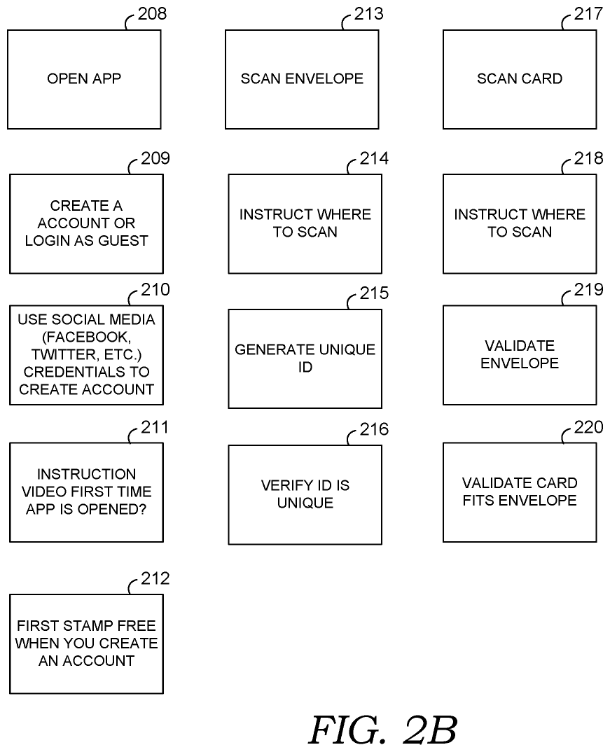

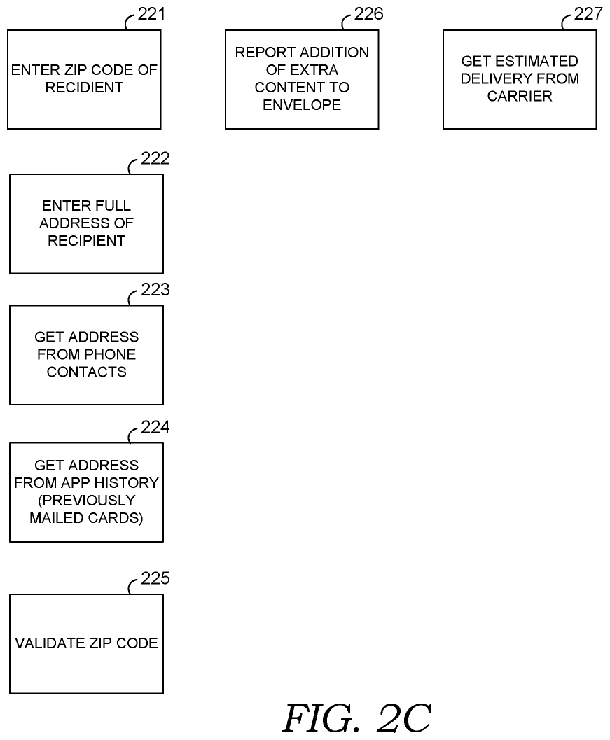

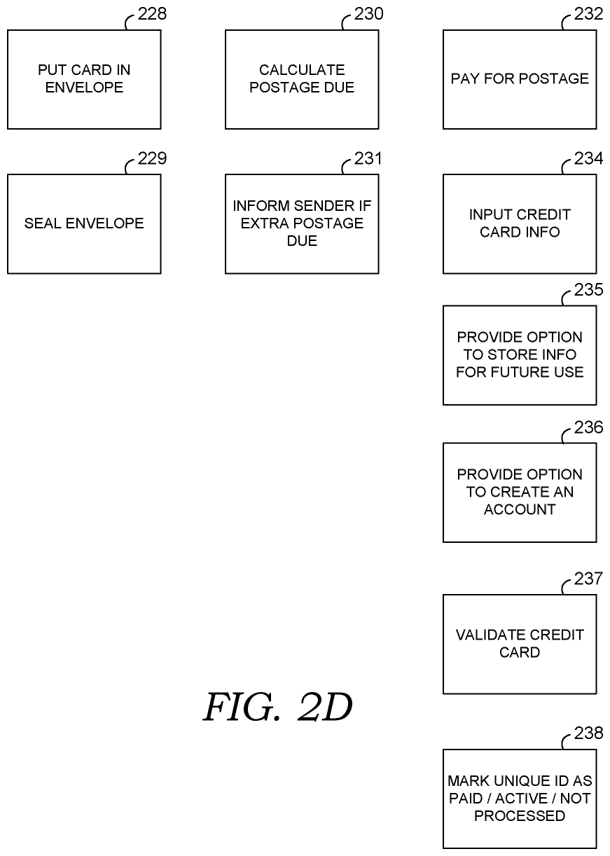

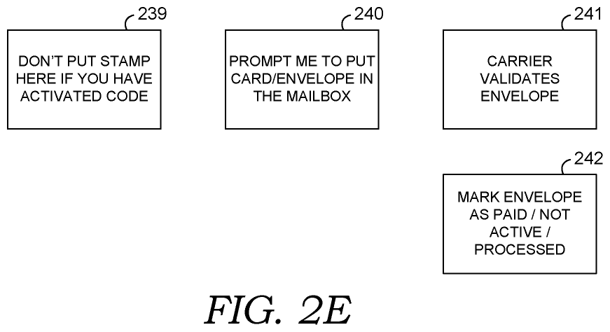

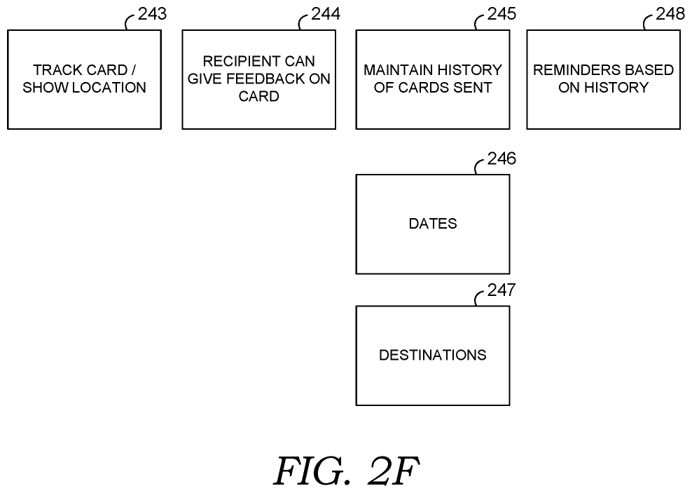

FIG. 2 is a flow diagram showing a method 200 for activating handwritten postage, according to an aspect of the technology described herein. FIG. 2 is broken into smaller portions that are enlarged and provided as FIGS. 2A-2F. Some of the steps shown may be performed in a different order than shown. Turning now to FIG. 2A, at step 201 the user decides whether to send the envelope via mail (i.e., he needs postage activated) or hand deliver the card to someone. The technology described herein allows for such an option, whereas pre-paid postage requires the user to pay for the postage at the time of purchase, whether they will use it or not, and without knowing if they will need additional postage. Here, there are no upfront costs and costs are only incurred if the user decides to activate handwritten postage.

At step 202, consumer awareness marketing of the app and the handwritten postage option is performed.

At step 203, the user may then download the handwritten postage app. This can be done manually by navigating to a webpage or searching for the app in an app store. As an alternative to the handwritten postage application, the user may navigate to a website in order to activate and purchase handwritten postage. At step 204, the handwritten postage activation app can be accessed by scanning the QR code on a handwritten postage postal item with a camera on a smart phone, tablet, or other device on which the application is to be installed. While installing the app, standard app set up questions may be asked to access a camera, GPS, contacts, or other device functions. At step 205, a request to access contacts is made. At step 206, a request to access a camera is made. At step 207, a request to access GPS (or location services) is made.

Turning now to FIG. 2B, at step 208 the user opens the app and at step 209 creates an account (or proceeds as a guest.) At step 210, the user supplies social media credentials to create an account. At step 211, an instruction video may be shown, if desired. At step 212, a free stamp or credit may be given.

At step 214, the app can output for display instructions showing a user how to take an image of the handwritten postage. At step 213, a user may capture an image of the handwritten postage from which a unique identifier may be generated. The image may be of the entire envelope or of a portion of it. If just a portion is captured, then the portion should include the handwritten signature and/or other writing. In aspects, multiple images could be captured. Each image could capture a different portion of the envelope. At step 215, the app generates a unique identifier from the image of the handwritten postage. The unique identifier can be generated by analyzing the image or images. The unique identifier can include data derived from the handwriting, such as content and handwriting characteristics (print, cursive, casual, formal). The content of the handwriting, such as the message content and/or address may be part of the unique identifier. The content may be determined through performing optical character recognition on the handwriting. In one aspect, content is also associated with a sender's user profile. For example, the name and address of a recipient could be added to a user's contact list. Any message detected could also be associated with the sender's profile. The saved recipient information could be retrieved to enable a sender to view messages send to various recipients over time. At step 216, the application can verify that the unique identifier is, in fact, unique. This may be accomplished by searching for a match between the unique identifier created at step 215 and existing unique identifiers in the system.

The app then requests information on the contents of a package on which the postage is printed or affixed. Where the contents are a greeting card, the user is prompted to scan the barcode (i.e., UPC) of the greeting card at step 217. At step 218, the app can show the user where to scan the UPC. At step 219, the card's barcode can be checked and information about the card can be compared to the envelope to confirm the card fits in the envelope being used, thereby validating the envelope at step 220.

Turning now to FIG. 2C, at step 221, the user is prompted to provide information about the destination of the envelope, such as the zip code. This information can be the full address (step 222). At step 223, the information can be pulled from the user's contacts. At step 224, the app can also store previous addresses used in a history file and that information can be provided to the user in order for the user to supply the destination address. At step 225, the entered zip code can be authenticated for accuracy. At step 226, the user can report what content has been added to the envelope. For example, the user could specify how many gift cards, photos, sheet of papers or the like have been inserted into the envelope. This specified content may be in addition to the previously scanned greeting card. An interface can be provided with common envelope content for the user to select as included and long with a specified amount for each item. At step 227, the app can obtain information from the carrier as to the estimated delivery of the envelope to the entered destination.

Turning now to FIG. 2D, at step 228, the user is prompted to put the card in the envelope and seal the envelope (step 229). At step 230, the app uses the gathered information to calculate the postage due. At step 231, the user can be prompted to see if they need to add extra postage because they have added additional items to the package. The user could be asked to specify the total weight of the envelope or weight of content added (in addition to the greeting card). The app can also inform the sender if extra postage is due from the obtained size data.

Once those items are handled, the user is instructed to pay for postage at step 232. At step 234, the user pays for the postage by inputting credit card information. The user may be asked to supply a payment method, such as a credit card to the application. Postage purchases may be made on an as-needed basis or postage could be purchased in a block, such as $50.00. If purchases in a block, individual postage transactions can be deducted from the available balance. At step 235, the user can be prompted to store the information for future use. At step 236, the user can be asked to create an account, if the user does not already have an account. At step 237, the credit card information is authenticated. At step 238, the central postage database is updated to indicate that the handwritten postage is paid and active, but not processed (i.e., previously used).

Turning now to FIG. 2E, at step 239, the app informs the user to not place a stamp on the envelope with the handwritten postage. At step 240, the user is prompted to place the envelope in a mailbox for collection. Once in the mail system, the carrier authenticates the handwritten postage at step 241. At step 242, the postage carrier can update the central postage database to show the handwritten postage is processed.

FIG. 2F illustrates some further steps that can be provided by the app and which are discussed in more detail below. For example, at step 243, the app can track and display the location of the envelope as it moves through the delivery process. This can include alerts to the user as the envelope nears the known destination. At step 244, the recipient, if also an app user, can give feedback to the sender on the card. At step 245, the app can keep a history of the cards sent to each recipient and the timing of the sending. At step 246, the date of the delivery is stored. At step 247, the destination of the delivery is stored. At step 248, this information can be used to help the app user in the future. For example, if the app determines from a previous use that the user sent a birthday card to someone on May 5th, the following year the app may send a notification to the user on April 25th asking if they want to get a birthday card for that person's upcoming birthday. The app may allow for shopping for that card through the app or directions to a nearby location where cards can be purchased. The app may even suggest cards based off of the previous genres sent to that particular recipient.

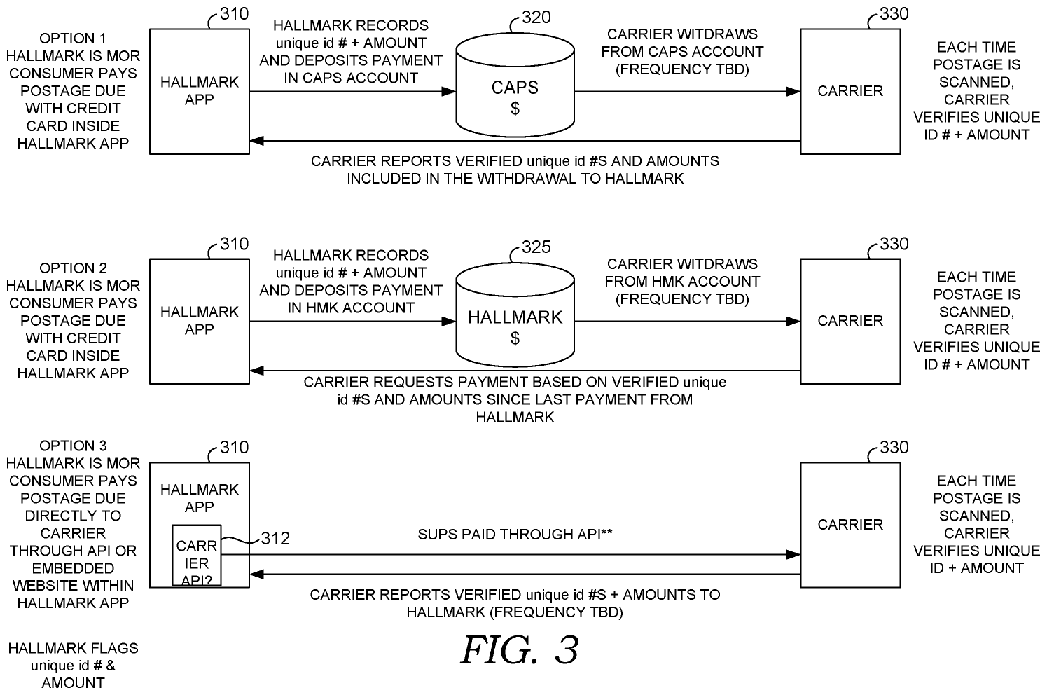

FIG. 3 illustrates various methods for collecting and distributing payment depending on the systems preferred by the app operator or delivery partner. For example, in Option 1, Hallmark is the Merchant of Record (“MOR”). Hallmark, as manufacturer of the envelopes, provides the app 310 and consumers pay postage due in the Hallmark app. Hallmark establishes a Centralized Account Processing System (“CAPS”) 320 account with the carrier. A CAPS account is the USPS's electronic postage payment system. Hallmark enters the unique identifiers and postage paid amounts in the CAPS account. The carrier 330 withdraws money for the processed handwritten postage instances from the CAPS account. The carrier performs the scanning and verification in the mail process. The carrier then reports to Hallmark the handwritten postage instances used/cancelled/activated/processed and the amounts withdrawn from the CAPS account.

In Option 2, Hallmark creates an account 325 separate from the CAPS system. The carrier still verifies the handwritten postage instances and amounts, but then requests payments based on those activations from the Hallmark account 325. In Option 3, the carrier is the MOR and, as such, the consumer pays the carrier directly for the postage, either through the Hallmark app or through an Application Programming Interface (“API”) 312.

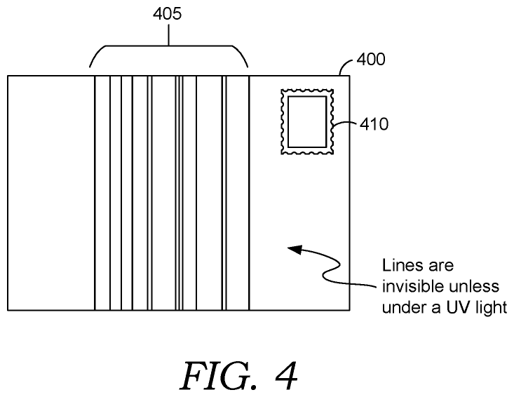

Turning now to FIG. 4, a handwritten postage envelope 400 is shown. A handwritten postage envelope 400 is an envelope printed with the purpose of using with handwritten postage. As such, the handwritten postage envelope 400 may include various visible and invisible pre-printed features that may facilitate handwritten postage generation and processing. The UV barcode 405 may indicate to the postal service that the envelope includes handwritten postage. Various areas may be designated, such as the stamp doodle area 410. Border designs to the various areas can include fiducial marks, labels (e.g., to, from, message), and other features. In one aspect, four fiducial marks are provided on the postal item. In one aspect, the border design around the stamp doodle area communicates information about the envelope, such as its size and weight. This information can be used by the handwritten postage application during activation to calculate postage. The border design can also be part of the unique identifier and validation identifier and used to guide an efficient matching process.

FIG. 5 illustrates that different border designs can indicate envelopes having different characteristics. The standard first class envelope 510 is shown having a stamp border design 515 with a double border in a portrait orientation. The over-sized envelope 520 is shown having a stamp border design 525 with a double border in a landscape orientation. The square envelope 530 is shown having a stamp border design 535 with a single border in a portrait orientation. Other combinations of border design characteristics can indicate different envelope characteristics.

FIG. 6 illustrates four different handwritten postage areas. Aspects of the technology are not limited to these four area or locations. Other areas could be on the back of the envelope. The handwritten postage areas include the from area 605, the to area 610, the customized message area 615, and the stamp doodle area 620. The handwritten postage can include instruction or suggestions for content to add to the stamp doodle area 620 and the customized message area 615. Though shown as boxes, other methods of visibly identifying the various areas are possible. The visibly boundaries of the various area may include fiducial marks. In aspects, only one or two of the areas include boundaries with fiducial marks.

Turning now to FIG. 7, a sender 714 first applies handwriting, such as signature 710, on the postal item 600, such as with a pen 712. In this example, the handwriting is applied to the customized message area 615 of the postal item 600. The customized message area 615 includes four fiducial markers. The first fiducial marker 701 is located in the upper left-hand corner of the customized message area 615. The second fiducial marker 702 is located in the lower left-hand corner of the customized message area 615. The third fiducial marker 703 is located in the upper right-hand corner of the customized message area 615. The fourth fiducial marker 704 is located in the lower right-hand corner of the customized message area 615. While the fiducial markers included here are stand-alone markers, integrated, or natural markers could also be used.

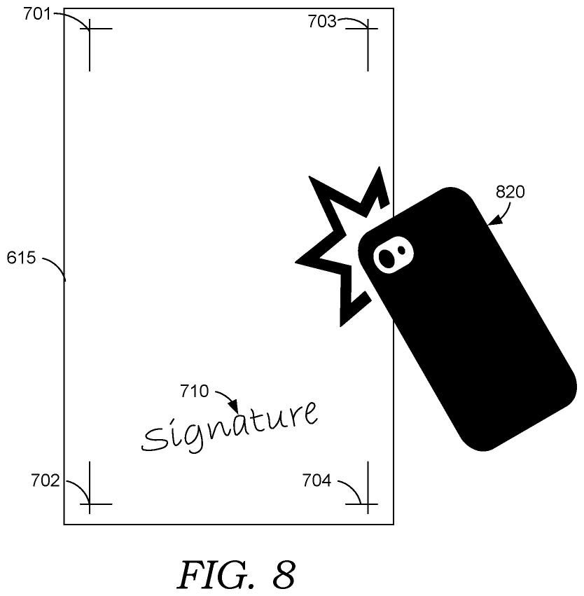

Turning now to FIG. 8, the sender opens a media-identification interface of a handwritten postage application running on a mobile device 720 and takes a picture of the customized message area 615, and possibly the entire postal item 600, with the mobile-device's camera. The handwritten-postage application interface may provide instructions that ask the user to capture the portion of the postal item, including the customized message area, stamp doodle area, from address area, and to address area. In implementations where fiducial marks are used, the portion of the envelope captured by the camera should include all fiducial marks required to generate a unique identifier.

The handwritten postage interface and/or greeting card application can perform a quality check on the image. If all required area are not within the captured image, then the sender may be prompted to capture a second image. Alternatively or additionally, the quality check can be performed in real time through analysis of the video being received through the camera and instructions provided to adjust the camera location as needed. If all required area are within the field of view, then the handwritten postage application instructs the user to capture an image, for example by tapping the screen. The handwritten postage application then generates a unique identifier using the image and possibly information, such as the to and from addresses and/or context information like the date of activation.

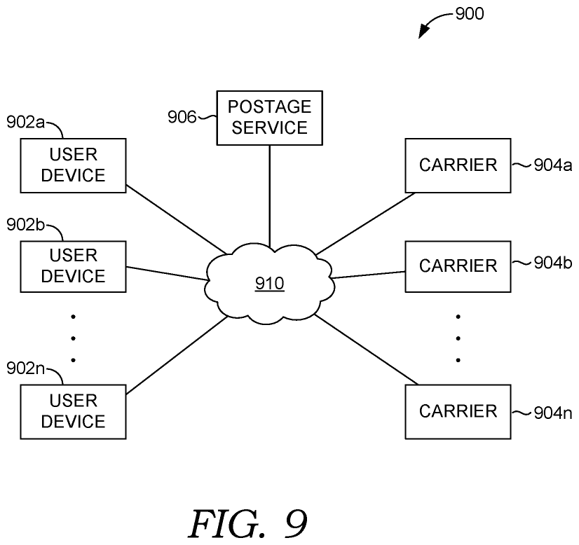

Turning now to FIG. 9, a block diagram is provided showing an operating environment 900 in which aspects of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

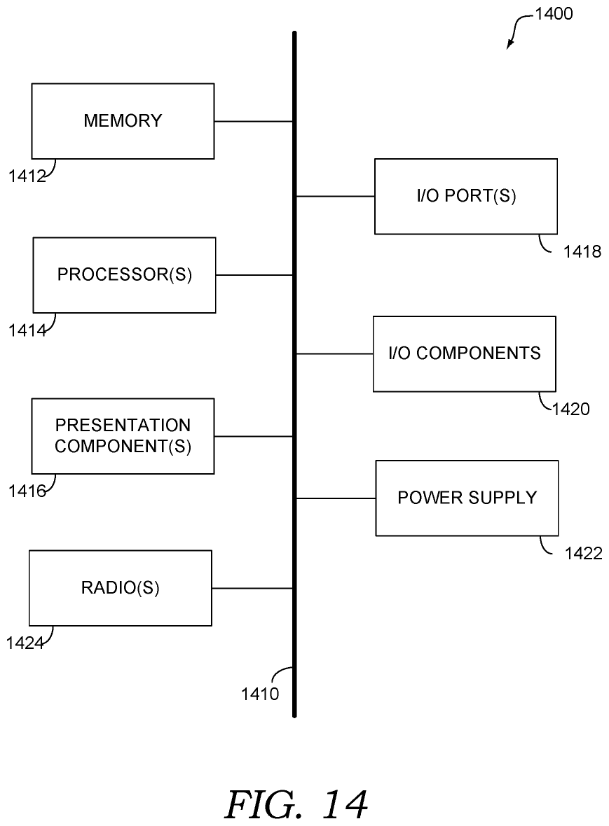

Among other components not shown, example operating environment 900 includes a number of user devices, such as user devices 902a and 902b through 902n; a number of carrier locations, such as carriers 904a and 904b through 904n; postage service 906; and network 910. It should be understood that environment 900 shown in FIG. 9 is an example of one suitable operating environment. Each of the components shown in FIG. 9 may be implemented via any type of computing device, such as computing device 1400, described in connection to FIG. 14, for example. These components may communicate with each other via network 910, which may include, without limitation, one or more local area networks (LANs) and/or wide area networks (WANs). In implementations, network 910 may comprise the Internet and/or a cellular network, amongst any of a variety of possible public and/or private networks.

It should be understood that any number of user devices, servers, and carrier locations may be employed within operating environment 900 within the scope of the present disclosure. Each may comprise a single device or multiple devices cooperating in a distributed environment. For instance, postage server 906 may be provided via multiple devices arranged in a distributed environment that collectively provide the functionality described herein. As an example, the postage server 906 may be a group of servers located at one or more different data centers. Additionally, other components not shown may also be included within the distributed environment.

User devices 902a and 902b through 902n can be client devices on the client-side of operating environment 900, while postage service 906 can be on the server-side of operating environment 900. Postage service 906 can comprise server-side software designed to work in conjunction with client-side software on user devices 902a and 902b through 902n so as to implement any combination of the features and functionalities discussed in the present disclosure. This division of operating environment 900 is provided to illustrate one example of a suitable environment, and there is no requirement for each implementation that any combination of postage service 906 and user devices 902a and 902b through 902n remain as separate entities.

User devices 902a and 902b through 902n may comprise any type of computing device capable of use by a user. The user devices may be personal devices, such as phones, tablets, or laptops or public devices, such as a computer associated with a postage activation kiosk. For example, in one aspect, user devices 902a through 902n may be the type of computing device described in relation to FIG. 14 herein. By way of example and not limitation, a user device may be embodied as a personal computer (PC), a laptop computer, a mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where handwritten postage may be activated.

Carrier locations 904a and 904b through 904n may comprise physical facilities for receiving and processing postal items, such as letters and packages. For example, a post office is an example of a single carrier location. The carrier location can include mechanical sorting equipment and postal processing equipment that authenticates the handwritten postage and then routes the item associated with the handwritten postage to its destination, possibly a second carrier location. Carrier locations can also include carrier-operated mobile devices, such as handheld scanners as might be used by a local messenger. The carrier locations can comprise computing systems that connect to the postage service 906.

The postage service 906 manages a database that tracks the status of handwritten postage. Initially, the database can be populated with a plurality of handwritten postage records. Each record can comprise a unique identifier associated with a single instance of handwritten postage. Other fields in the record can include a status field that can be either activated or deactivated, a postage value associated with the record, the destination ZIP Code, date of activation, date of deactivation, and the like. The postage service 906 may be implemented across a series of servers in multiple data centers. The postage service 906 interfaces with user devices in order to activate individual instances of handwritten postage. The postage service 906 also interfaces with carrier locations in order to deactivate individual instances of handwritten postage. The postage service 906 can also interface with different payment systems, as needed.

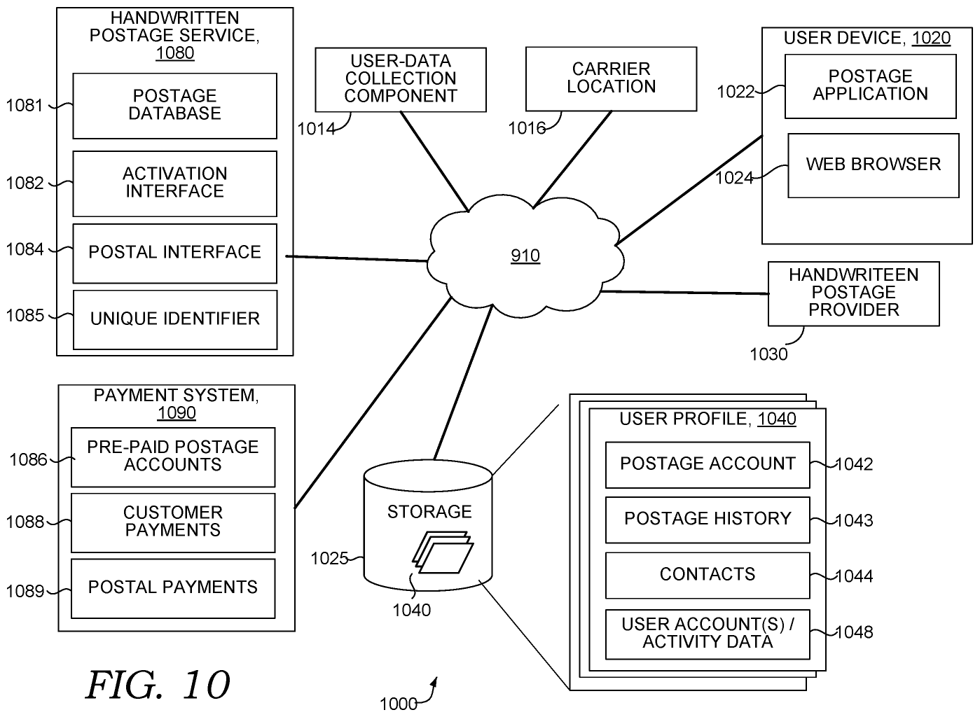

Operating environment 900 can be utilized to implement one or more of the components of system 1000, described in FIG. 10, including components for collecting user data, monitoring communication events, generating modified notifications, and/or presenting notifications and related content to users.

Referring now to FIG. 10, with FIG. 10, a block diagram is provided showing aspects of an example computing system architecture suitable for implementing an aspect of the technology and designated generally as system 1000. System 1000 represents only one example of a suitable computing system architecture. Other arrangements and elements can be used in addition to or instead of those shown, and some elements may be omitted altogether for the sake of clarity. Further, as with operating environment 900, many of the elements described herein are functional entities that may be implemented as discrete or distributed components or in conjunction with other components, and in any suitable combination and location.

Example system 1000 includes network 910, which is described in connection to FIG. 9, and which communicatively couples components of system 1000 including user-data collection component 1014, carrier location 1016, user device 1020, handwritten postage provider 1030, handwritten postage service 1080, payment system 1090, and storage 1025. Handwritten postage service 1080 (including its components 1081, 1082, and 1084), user-data collection component 1014, and payment system 1090 (including its components 1086, 1088, and 1089) may be embodied as a set of compiled computer instructions or functions, program modules, computer software services, or an arrangement of processes carried out on one or more computer systems, such as computing device 1400 described in connection to FIG. 14, for example.

In one aspect, the functions performed by components of system 1000 are associated with one or more applications, services, or routines. In particular, such applications, services, or routines may operate on one or more user devices (such as user device 902a), servers (such as server 906), may be distributed across one or more user devices and servers, or be implemented in the cloud. Moreover, in some aspects, these components of system 1000 may be distributed across a network, including one or more servers (such as server 906) and client devices (such as user device 902a), in the cloud, or may reside on a user device such as user device 902a. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 1000, it is contemplated that in some aspects functionality of these components can be shared or distributed across other components.

Continuing with FIG. 10, user-data collection component 1014 is generally responsible for accessing or receiving (and in some cases also identifying) user data from one or more data sources. The user data can include a history of postage purchases, destination information, product purchases, account information, social network information, payment information, and other information related to handwritten postage. In some aspects, user-data collection component 1014 may be employed to facilitate the accumulation of user data of one or more users for the handwritten postage service 1080. The data may be received (or accessed), and optionally accumulated, reformatted, and/or combined, and stored in one or more data stores such as storage 1025, where it may be available to handwritten postage service 1080. For example, the user data may be stored in or associated with a user profile 1040, as described herein.

The user profile 1040 stores a variety of information gleaned from a user's purchase of handwritten postage, postage activity, purchase activity, and other related activity. The user may be provided opt in or opt out interface where the information being stored in a user profile is explained to the user. The user may be given the option to exclude various data sources or data from the user profile. The user may be given the option to delete existing records, correct information, and provide feedback about the information in the user profile.

The user information can include details about a postage account 1042. Postage account 1042 helps facilitate activation of handwritten postage. The postage account 1042 may comprise a user ID and password. The postage account 1042 can also be associated with various payment methods. The postage account 1042 can include unique identifiers for different user devices. Information such as a home address, work address, application versions, email addresses, phone numbers, and the like may also be stored in the postage account 1042. The postage account for a single user profile could also be associated with multiple users in the same household or family.

The postage account 1042 can facilitate a prepaid handwritten postage account. The user may pay in advance for an amount of postage. In this scenario, the postal value assigned to handwritten postage is debited from the prepaid account upon activation. The user may receive notices when the account value passes below a threshold. The user may be given the option of replenishing the account through the activation application when an handwritten postage instance is being activated and the prepaid account falls below a threshold.

The postage history 1043 stores a record of postage purchased, destinations the purchased postage was used to send items to, and any other information about the user's use or purchase of handwritten postage and/or other types of postage.

The contacts record 1044 may comprise a contacts record accessible to an activation application residing on a user device. In one instance, the user gives the activation application permission to access the contacts on the user device. In another instance, the contacts 1044 are from a separate source, such as the destination addresses used on handwritten postage. The contacts 1044 can include social media contacts, work contacts, or other contacts affiliated with the user. The contact record 1044 can include the home or work address of people the user knows (e.g., contacts).

The user accounts activity data 1048 provides information about one or more separate accounts, such as email or social media accounts. In one aspect, a user is able to authenticate himself to the activation system using social media credentials. If the user selects this authentication method, then the credentials may be associated with the user profile 1040.

The handwritten postage provider 1030 can provide handwritten postage postal items (e.g., envelopes, boxes, and post cards) in a number of formats. In one aspect, the handwritten postage provider 1030 is an entity that prints handwritten postage envelopes, stickers, or other media. The handwritten postage envelopes include printed content that facilitates the generation and/or use of handwritten postage. This content may include fiducial marks, borders, and marks, such as a barcode, that identifies the envelope as containing handwritten postage to a carrier. A postage provider 1030 can contract with one or more carriers for the handwritten postage to be valid. Unlike stamps, the handwritten postage could be accepted by multiple carriers. Multiple carriers could access the handwritten postage service 1080 and receive compensation by validating and deactivating an instance of handwritten postage.

The handwritten postage provider 1030 can also provide a postage application 1022 and the payment system 1090. Further, the handwritten postage service 1080 can be set up and run by the handwritten postage provider 1030. The handwritten postage provider 1030 can take an interest in individual transactions. For example, the handwritten postage provider 1030 can agree to make up the difference between a postage value assigned to a handwritten postage instance and a calculated postage rate charged by the carrier for the item associated with the instance. Similarly, the handwritten postage provider 1030 can manage the user profiles 1040, in other aspects of the system.

The user device 1020 comprises a handwritten postage application 1022 and a web browser 1024 among many other components not shown. The user device 1020 can be similar to the user devices 902a described previously with reference to FIG. 9. Both the handwritten postage application 1022 and the web browser 1024 may be used to activate postage through the user device 1020. In either instance, aspects of the activation process may be performed by components operating on computing devices apart from the user device 1020.

The handwritten postage service 1080 includes a postage database 1081, an activation interface 1082, a postal interface 1084, and a unique identifier component 1085.

The unique identifier component 1085 receives an image from a user device and/or postal camera and generates a unique identifier or validation identifier. These two items are generated using the same visual analysis process to generate comparable data. The unique identifier is generated during the activation process. The validation identifier is generated during validation by a postal carrier. In both cases, an input to the generation process is an image or images of the handwritten postage. In the multiple image case, each area of the handwritten postage may be captured in an individual image. In the single image case, all of the handwritten postage is captured in a single image. In some aspects, the unique identifier component 1085 could be located on a user device and also in a postal validation system (not shown). In other aspects, it is located in the cloud and accessed by the user device and postal system.

The unique identifier component 1085 can receive images from both the sender's device and the postal validation device. Similar processes can be performed in either case. In the case of the sender or activator of the postage, the image can be received and processed to generate a unique identifier. In the case of the postal validation device, a second image of the handwritten mark (e.g., envelope, portion thereof, or portions thereof) may be captured and the validation identifier generated and compared to existing identifiers in the system.

An image feature extractor that is part of the unique identifier component 1085 can extract features from a signature or other handwritten marking received. Features extracted from the image can be used to index the unique identifiers and can become part of the unique identifier. The image feature extractor may identify the location of the handwritten marking on the visual media using the fiducial marks. The location can be identified as a center point of the handwritten marking. The location also could be identified as a distance from a fiducial mark. For example, a distance between the leftmost pixel including a portion of the signature and a fiducial mark could be one distance. A second distance could be the distance between the right most pixel and a fiducial mark. Multiple distances can be calculated in this manner between various aspects of the signature or other handwritten marking and various fiducial marks within the image. Collectively, the plurality of distances calculated could define the handwritten marking location.

In one aspect, four or more points on the handwritten marking are identified. For example, the rightmost, leftmost, topmost, and lowest pixels that include a portion of the handwritten marking may be identified. If the handwritten marking image was converted to black-and-white, with black pixels representing the ink, the above-referenced pixels could be identified by analyzing an area of the image associated with the handwritten marking and isolating black pixels. A distance calculation for each of these identified pixels to one or more fiducial markers can be made. Thus, if two fiducial markers are used along with the four pixels mentioned, then eight distance calculations could be made. These distance calculations could be combined in a hash function or some other manner to create a single number that represents the location of the handwritten marking. The single number could serve as part of the unique identifier. This process could be repeated for each area of the handwritten postage. Thus, a location of the to address, a location of the from address, a location of the stamp doodle, and a location for the custom message are determined. While it is possible that multiple handwritten markings could result in the same single number, the single number is only one part of the unique identifier. The other part comprises an image of the handwritten marking. Thus, the single number could be used to select a small subset of stored unique identifiers for further analysis in response to receiving an image from a postal service.

Other features can also be identified. For example, the color of the ink used to make the handwritten marking can be a feature. The angle at which the handwritten marking, such as a signature, was made can be another feature. The comparison of dark content to light content of the handwriting area may be another feature. For example, the number of dark pixels compared to the number of light pixels. The saturation of the handwriting within a message area is not another feature that can be used in the comparison. Similarly, the height and length of the handwritten marking are features. Not all signatures are easily converted to letters, but a feature can include one or more letters extracted from the signature along with a confidence that the letter was correctly identified. For example, the to and from address can each be features along with the content of a customized message. In one aspect, the content of the customized message is not extracted for the purpose of preserving privacy. Extraction of other features is possible.

The unique identifier component 1085 generates the unique identifier or validation identifier. In its simplest form, the unique identifier is the image itself. In another aspect, the unique identifier is the image after undergoing some preprocessing, such as de-noising. In one instance, the image can be converted to a black-and-white image. The fiducial marks can be used to scale the handwritten marking to a common scale used to compare all handwritten marking. The unique identifier can also include location characteristics of the handwritten marks.

The unique identifier component 1085 can also compare the handwritten postage image in a first unique ID stored on the system to the handwritten postage image provided by a postal validation service. In one aspect, a pixel-by-pixel comparison is made of the unique identifier image to the validation image. In another aspect, a machine-learning system, such as a convolutional network, is used to perform the comparison. When the pixel-by-pixel comparison reveals a match, then the unique identifier component 1085 can provide a match message to a requesting component, such as the carrier location 1016.

In addition to the handwritten postage image, content, such as the to and from address, or part of the address, can form part of both the unique identifier and the validation identifier. Any pre-printed content, such envelope characteristics encoded in a stamp doodle boarder, can be part of the identifiers. Activation context (e.g., location, date, envelope size and weight) can be part of the unique identifier. Validation context (e.g., location, date, envelope size and weight) can be part of the validation identifier.

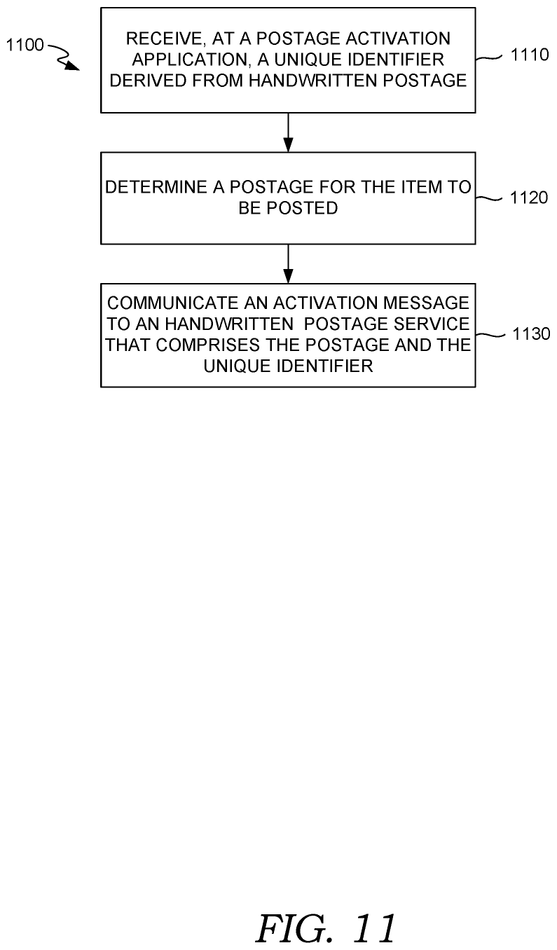

Turning now to FIG. 11, a method 1100 of activating pre-printed postage from a computing device is provided. The computing device may be a user device, such as described previously reference to user device 1020. The activation process of method 1100 may utilize an activation application running on a computing device. The activation process may use a web browser or other application to access a web page through which the postage may be activated according to the steps described below. In one aspect, the computing device is a user device such as a smart phone, PC, or tablet. In another aspect, the computing device is part of a kiosk provided in a public location, such as a post office or store. In one aspect, an activation kiosk is provided within or nearby a stationery section of a drug store, grocery store, or other store where greeting cards and other stationery may be purchased.

Initially, the user may gain access to an activation application. In one example, the user downloads and installs an activation application on his or her user device. In another aspect, the user accesses an application through a webpage. In yet another example, the user accesses an activation application at a publicly available computing device. The activation application may ask the user to login with credentials and follow an authentication process. As part of this process user information may need to be provided as described previously.

The activation application can guide the user through the activation process with tips or prompts for various steps displayed through a graphical user interface. Initially, the user may be prompted to scan the handwritten postage the user wants to activate. The user can scan the handwritten postage using the camera on the user device. The user interface may show a camera view in a portion of the screen to help the user see where the camera is pointed. Once an adequate image is captured, the user may be informed the scanning process is complete.

At a minimum, the handwritten postage comprises a user's handwriting that can be used to form a unique identifier. The handwritten postage could be printed on a sticker that can in turn be affixed to the item to be posted.

At step 1110, a unique identifier derived through a visual analysis of the handwritten postage printed on a postal item is received at a postage activation application. The handwritten postage may be printed by a person writing on the envelope or through electronic ink, as described previously. In order to activate an individual instance of handwritten postage, the unique identifier must be generated from an image of the envelope on which the handwritten postage resides. For example, the camera on a smart phone may capture an image of the handwritten postage. The image can be provided by the camera to the activation application which performs a visual analysis to generate the unique identifier.

At step 1120, a postage rate required for the item to be posted may be determined. In some cases, a flat rate may be charged to post an item to a geographic area, such as a country, as with a first class stamp. In that case, the item to be posted needs to meet certain size/weight requirements, but other information (e.g., destination address or shipping location) is not required. In other cases, the size and weight of the package may be needed along with the destination address to calculate the postage rate. The user can be prompted to provide information about the item to be posted in order to calculate the postage rate. The information can include a size and weight of the item. Alternatively, the activation application can provide examples for the user to select in order to estimate a size and weight. For example, a user can be asked to select images of envelopes having different sizes with different amounts of paper in each envelope. Every size combination does not need to be provided, instead representative sizes and amounts of paper can be used to estimate the appropriate postage rate for the item.

In one aspect, a UPC label on a greeting card or other commercial product may be scanned to retrieve a size and weight of the item. The activation application may prompt the user to scan the UPC label on greeting card or other item. The activation application may look up information about a commercial product from a database. The activation application may use a backend service to perform this function. Alternatively, the activation application may have a local record of some UPC labels and corresponding postal information. The user may also be asked to provide a destination address. In one aspect, the activation application includes the ability to read handwriting. In this instance, the destination address could be obtained by scanning the address listed on the item. In another aspect, an address can be selected from the user's contact information. User may be transferred to a contact interface on the user device in order to select a contact and corresponding address. The user may be asked to select different postal options, such as first-class mail, express shipping, next day delivery, media mail, or some other option.

Once the item information is provided and postal options selected, the postage rate is calculated. The user may be asked to confirm the amount or authorize payment in the amount of the calculated postage rate. A postal value equal to the calculated postage rate will then be associated with the handwritten postage.

At step 1130, an activation message is communicated to a handwritten postage service. The activation message comprises the unique identifier. The message may also comprise a postage value to associate with the unique identifier within the handwritten postage database. This allows a carrier to confirm that the item has adequate postage by comparing the postal value in the database to an assessed postage rate calculated by analyzing the item and associated shipping information, such as the destination address. Once confirmation is obtained, the activation application sends a message to a central postage service. The handwritten postage service updates a central database to associate the unique identifier with a postal value provided. Other information may also be included within the message, such as a destination ZIP Code and user ID of the user activating the postage. The postal value provided may not be equal to an amount charged to a customer. For example, the customer may be charged service fees or other costs, in which case the postal value may be less than what the customer was charged. Other payment processing methods are possible. For example, the customer may purchase credits that may be used to activate postage. In this case, the value may be based on the credits, but not map in a one-to-one way to the postage rate.

In one aspect, the postage value is not provided to the handwritten postage service. For example, the carrier may decide that it does not wish to evaluate each item to confirm that the correct postage rate was charged. In this case, it is sufficient for the handwritten postage service to know that the instance of handwritten postage is usable as postage, without reference to the postage value paid. The carrier may determine that the activation process accurately calculates a postage rate and that double checking the calculation is not a desirable use of resources.

However, in other implementations the carrier confirms that the correct postage rate was paid. In the event of a miscalculation of the postage rate, the user may pre-authorize the central postage service to charge the user a difference between the calculated postage rate and a postage rate subsequently assessed by the carrier.

Returning to FIG. 10, payment for the postage value assigned to a handwritten postage instance can be processed by the payment system 1090. In one aspect, user's for entities such as companies, pay advance to create a pre-paid postage account. These accounts are managed by the pre-paid account component 1086. The prepaid postage account component can track the balance in various accounts and provide balance updates to users.

The customer payment component 1088 is responsible for receiving funds from customers activating handwritten postage. The customer payments component 1088 can receive payment from credit cards and other payment methods. The customer payment component 1088 can control the timing of customer payments. In one aspect, customer charges on a credit card are accumulated for an hour, day or some other time and passed along as a group. In one aspect, charges are accumulated so long as an active application session is ongoing. An active application session may be ongoing when the activation is open and continues to receive input without an interruption lasting longer than a threshold duration, such as five minutes. At the conclusion of the activation session, the sum of all postage values added to handwritten postage during the session are charged as a lump sum to the user's credit card or payment method.

The postal payments component 1089 is responsible for transferring funds to a carrier that received an item posted using handwritten postage. In one aspect, funds are transferred to the postal payment component 1089 upon activation of an instance of handwritten postage. In another instance, funds are transferred to the carrier on the carrier providing a deactivation message to the handwritten postage service 1080.

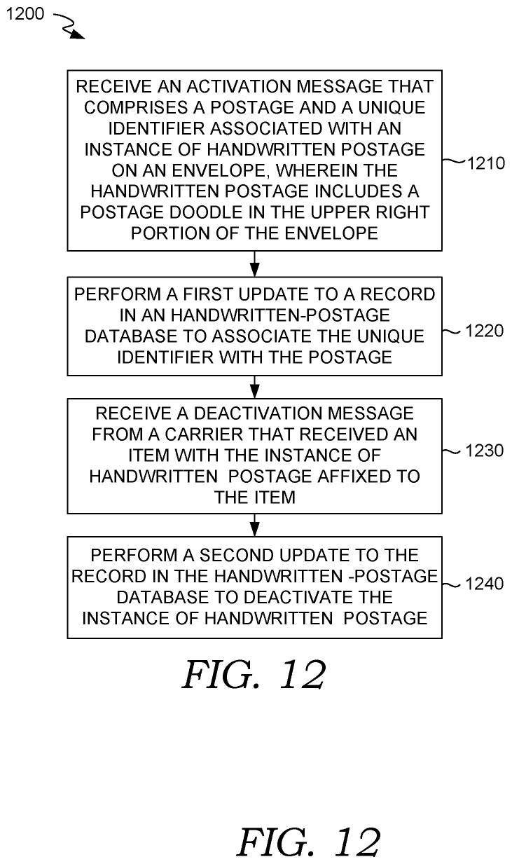

The handwritten postage service 1080 comprises a postage database 1081, an activation interface 1082, and a postal interface 1084. The postage database 1081 includes records for individual instances of handwritten postage. The information included in each record can vary, but exemplary information includes the unique identifier associated with the instance of handwritten postage, postage amount associated with the record, and active/deactive status, a date postage was added to the record, a date postage was deactivated, carrier identification, carrier location identification, destination information, and user identification information. The activation interface 1082 helps facilitate the activation process for interfacing with an activation application, such as activation application 1022. The activation interface 1082 can receive an activation instruction and provide an instruction to update the postage database 1081 according to the activation instruction. The postal interface 1084 communicates with the carrier location 1016. The handwritten postage service 1080 can update the activation status of handwritten postage, as described with reference to FIG. 12.

Turning now to FIG. 12, a method 1200 for tracking an activation status of handwritten postage is provided. At step 1210, an activation message that comprises a postage value and a unique identifier associated with an instance of handwritten postage is received on an envelope. The handwritten postage includes a postage doodle in the upper right portion of the envelope. The activation message may be received from an activation application. The postage value may be calculated by the activation application for a particular item to which handwritten postage is attached. The unique identifier will correspond with the handwritten postage attached to the item.

At step 1220, a first update is performed on a record in a handwritten postage database to associate the unique identifier with the postage value. Other information may be updated, such as the date of activation, the user associated with the activation, and activation entity responsible for the handwritten postage, and the like.

At step 1230, a deactivation message is received from a carrier that received an item with the instance of handwritten postage affixed to the item. The carrier will respond by deactivating the postage so that it cannot be reused without further steps being taken. For example, the database may be updated to indicate the handwritten postage has been processed.

At step 1240, a second update is performed on the record in the handwritten postage database to deactivate the instance of handwritten postage. The field may be provided to describe the activation status of the handwritten postage instance. Once deactivated, the handwritten postage instance will not be usable the second time without reactivation by going through the reactivation process a second time.

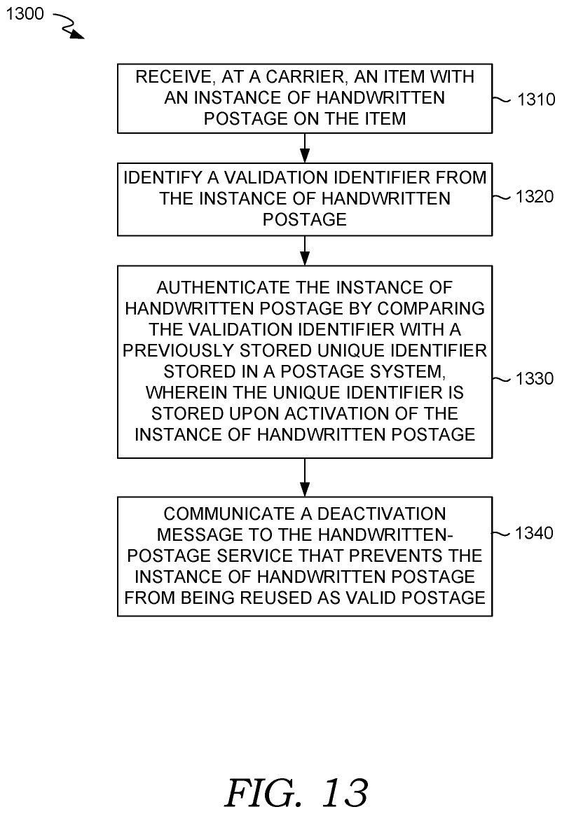

Returning to FIG. 10, the carrier location 1016 can be similar to the carrier locations described previously with reference to FIG. 9. For example, the carrier location 1016 can be the post office. The carrier location 1016 is responsible for receiving and processing items that are posted using handwritten postage. As part of the processing, the carrier location 1016 will authenticate handwritten postage and then deactivate it by communicating with the handwritten postage service 1080. FIG. 13 describes a method for validating and deactivating postage that may be performed by the carrier location 1016.

Turning now to FIG. 13, a method 1300 of processing handwritten postage is provided. When the Postal Service receives an item with handwritten postage it authenticates the handwritten postage and then deactivates the handwritten postage.

At step 1310, the method 1300 includes receiving, at a carrier, an item with an instance of handwritten postage on the item. The carrier location, such as a post office, can use automated machinery to process and route items. In one aspect, items having handwritten postage are identified by scanning the postage on the items. Different types of postage may be processed different ways. Once identified, the handwritten postage is authenticated. Validating the postage comprises identifying a postage value currently associated with the handwritten postage and comparing it to an assessed postage rate for the item.

At step 1320, the method 1300 includes identifying a validation identifier from the instance of handwritten postage. A described previously, a validation identifier may be generated from an image of the handwritten postage.

At step 1330, the method 1300 includes authenticating the instance of handwritten postage by comparing the validation identifier with a previously stored unique identifier stored in a postage system. The unique identifier is stored upon activation of the instance of handwritten postage. In one aspect, authenticating the postage is done by sending a message with the validation identifier to the handwritten postage service. The validation identifier is then compared to a unique identifier to determine whether the handwritten postage is valid. If a match (possibly within a threshold) is found and the database indicates the unique identifier is active, then the handwritten postage is found valid. Otherwise, it is found invalid. When the service responds with a confirmation that the postage is to be accepted as postage then the authentication is complete. In another aspect, the carrier also confirms that the item is associated with the correct amount of postage for its characteristics and route. In this case, several additional steps are taken.

First, a correct postage rate is assessed for the item by the carrier. The correct postage may be assessed according to a size and weight of the item, postage class, delivery location, and other factors. The correct postage rate may be assessed at any point in the process prior to the comparison of the correct postage rate with the postage value associated with the handwritten postage.

Next, a request is communicated to a handwritten postage service for a postage value associated with the unique identifier. The request can take any number of forms. In one aspect, an asynchronous queue-based communication is set up between the carrier location and handwritten postage service. This system allows an open channel of communications to be maintained. When activated postage needs authentication, a request is communicated to a queue in the handwritten postage service. The service then processes the request and provides a response by looking up the requested information in a handwritten postage database. In general, a request for the associated postage value only requires the unique identifier, but can include different information. The request itself may include a request ID that is used to respond to the specific request.

Next, the postage value is received from the handwritten postage service. The postage value may be returned in a response message.

Next, the postage value is compared to the correct postage rate. Various actions can be taken based on comparison. In the simplest case when the postage value is greater than or equal to the postage rate, the item is processed and routed to its destination. Various things can occur when the postage value is less than the postage rate. In one case, the carrier can handle the item as it would handle any other item with inadequate postage. For example, the post office could ask for the recipient to supply the difference between the calculated rate and the postage value.

In one aspect, aspects of the technology allow postage value associated with unique identifier to be adjusted upwards to match the assessed rate. As mentioned, the user may preauthorize the application interface and corresponding service to debit the user's account in the amount of any postage shortfall. Alternatively, an entity providing the handwritten postage may take on responsibility for the shortfall itself. In either case, a message can be communicated to the handwritten postage service 1080 requesting additional funds to make up the difference. When a system is in place to adjust the shortfall either by charging the user or the entity activating the postage then an updated postage value may be provided in the exact amount of the assessed rate. The authentication process can then restart using the updated postage value.

At step 1340, the method 1300 includes communicating a deactivation message to the handwritten postage service that prevents the instance of handwritten postage from being reused as valid postage. Once the carrier has processed the item and authenticated the handwritten postage, a message to deactivate the postage is provided. The message can include the unique identifier as well as relevant information, such as the assessed rate. The assessed rate can act as feedback that helps the activation application improve the postage rate estimates that provider users. The deactivation message can include identification of the carrier location. In an aspect, the handwritten postage service 1080 can interface with multiple carriers. Carriers may receive compensation in the amount of the assessed postage rate upon receiving a deactivation message.

With reference to FIG. 14, computing device 1400 includes a bus 1410 that directly or indirectly couples the following devices: memory 1412, one or more processors 1414, one or more presentation components 1416, one or more input/output (I/O) ports 1418, one or more I/O components 1420, and an illustrative power supply 1422. Bus 1410 represents what may be one or more busses (such as an address bus, data bus, or combination thereof). Although the various blocks of FIG. 14 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 14 is merely illustrative of an exemplary computing device that can be used in connection with one or more aspects of the present technology. Distinction is not made between such categories as “workstation,” “server,” “laptop,” “handheld device,” etc., as all are contemplated within the scope of FIG. 14 and with reference to “computing device.”

Computing device 1400 typically includes a variety of computer-readable media. Computer-readable media can be any available media that can be accessed by computing device 1400 and includes both volatile and nonvolatile media, removable and non-removable media. By way of example, and not limitation, computer-readable media may comprise computer-storage media and communication media.

Computer-storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 1400. Computer storage media does not comprise signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 1412 includes computer storage media in the form of volatile and/or nonvolatile memory. The memory may be removable, non-removable, or a combination thereof. Exemplary hardware devices include solid-state memory, hard drives, optical-disc drives, etc. Computing device 1400 includes one or more processors 1414 that read data from various entities such as memory 1412 or I/O components 1418. Presentation component(s) 1416 presents data indications to a user or other device. Exemplary presentation components include a display device, speaker, printing component, vibrating component, and the like.

The I/O ports 1418 allow computing device 1400 to be logically coupled to other devices, including I/O components 1420, some of which may be built in. Illustrative components include a microphone, joystick, game pad, satellite dish, scanner, printer, wireless device, etc.

The I/O components 1420 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1400. The computing device 1400 may be equipped with depth cameras, such as stereoscopic camera systems, infrared camera systems, RGB camera systems, and combinations of these, for gesture detection and recognition. Additionally, the computing device 1400 may be equipped with accelerometers or gyroscopes that enable detection of motion. The output of the accelerometers or gyroscopes may be provided to the display of the computing device 1400 to render immersive augmented reality or virtual reality.

Some aspects of computing device 1400 may include one or more radio(s) 1424 (or similar wireless communication components). The radio 1424 transmits and receives radio or wireless communications. The computing device 1400 may be a wireless terminal adapted to receive communications and media over various wireless networks. Computing device 1400 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Aspects of the present technology have been described with the intent to be illustrative rather than restrictive. Alternative aspects will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

The invention claimed is:

1. A method of activating postage from a computing device, comprising:
receiving, at a postage-activation application, a unique identifier derived from a visual analysis of handwritten postage printed on an item; and
communicating, from the postage-activation application, an activation message to a handwritten postage service that comprises the unique identifier.

2. The method of claim 1, further comprising determining a postage rate required for the item to be posted and communicating a postage value that is associated with the unique identifier to the handwritten postage service.

3. The method of claim 2, wherein said determining the postage rate comprises identifying a greeting card to be sent in the item by scanning the greeting card and looking up specifications for the greeting card in a greeting card database.

4. The method of claim 3, wherein the greeting card is identified through computer vision analysis of a visual design on the greeting card.

5. The method of claim 1, wherein the instance of handwritten postage is not associated with any postage value at a time of said receiving.

6. The method of claim 1, wherein the instance of handwritten postage comprises a handwritten message in a designated message area of the item.

7. The method of claim 1, wherein the instance of handwritten postage comprises a handwritten postage doodle in a designated stamp area of the item.

8. A method for tracking an activation status of handwritten postage, comprising:
receiving an activation message that comprises a postage value and a unique identifier associated with an instance of handwritten postage on an envelope, wherein the handwritten postage includes a postage doodle in the upper right portion of the envelope;
performing a first update to a record in an handwritten postage database to associate the unique identifier with the postage value;
receiving a deactivation message from a carrier that received an item with the instance of handwritten postage affixed to the item; and
performing a second update to the record in the handwritten postage database to deactivate the instance of handwritten postage.

9. The method of claim 8, further comprising receiving a request from the carrier to provide the postage value and communicating a response to the carrier with the postage value.

10. The method of claim 8, wherein the unique identifier was in the handwritten postage database prior to receiving the activation message.

11. The method of claim 8, wherein the upper right portion of the envelope includes fiducial marks that bound the postage doodle.

12. The method of claim 8, wherein the instance of handwritten postage comprises a handwritten message in a designated message area of the envelope, wherein the designated message area is located on the right half of the envelope.

13. The method of claim 8, wherein the record was not associated with a value before the first update.

14. The method of claim 8, wherein the record includes a date the handwritten postage was activated.

15. A method of processing handwritten postage, the method comprising:
receiving, at a carrier, an item with an instance of handwritten postage on the item;
identifying a validation identifier from the instance of handwritten postage;
authenticating the instance of handwritten postage by comparing the validation identifier with a previously stored unique identifier stored in a postage system, wherein the unique identifier is stored upon activation of the instance of handwritten postage; and
communicating a deactivation message to the handwritten postage service that prevents the instance of handwritten postage from being reused as valid postage.

16. The method of claim 15, wherein the instance of handwritten postage comprises a handwritten message in a designated message area of the item.

17. The method of claim 15, wherein the instance of handwritten postage comprises a handwritten postage doodle in a designated message area of the item.

18. The method of claim 15, wherein the designated message area includes fiducial marks.

19. The method of claim 15, wherein the handwritten message includes a handwritten signature of a sender.

20. The method of claim 15, wherein the instance of handwritten postage includes a handwritten address on the item.
